(19) United States
(12) Patent Application Publication
(10) Pub. No.: US 2026/0304433 A1
(43) Pub. Date: Oct. 1, 2026

(54) PHYSICAL UPLINK SHARED CHANNEL REPETITIONS IN SUBBAND FULL DUPLEX OPERATIONS

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Mohammed JABI, San Diego, CA (US)

(21) Appl. No.: 19/532,813

(22) Filed: Feb. 6, 2026

Related U.S. Application Data
(60) Provisional application No. 63/779,104, filed on Mar. 27, 2025.

(51) Int. Cl. H04W 72/21; H04W 72/0446; H04W 72/23

(52) U.S. Cl. CPC H04W 72/21; H04W 72/0446; H04W 72/23

(57) ABSTRACT

This disclosure provides methods, components, devices and systems for physical uplink shared channel (PUSCH) repetitions in subband full duplex (SBFD) operations. For example, a user equipment (UE) may identify a set of actual repetitions of a PUSCH from a set of nominal repetitions according to valid symbol types. In some examples, the valid symbol types for the PUSCH repetitions may correspond to either uplink symbols or SBFD symbols (but not both), where the UE may determine the valid symbol type according to a symbol type of a first transmission occasion of the set of nominal repetitions, according to a symbol type of a first transmission occasion of the set of actual repetitions, or according to an indication from the network entity. In some other examples, the valid symbol types for the PUSCH repetitions may correspond to both the uplink symbols and the SBFD symbols.

### CROSS REFERENCE

This present application for patent claims benefit of U.S. Provisional Patent Application No. 63/779,104 by ABDELGHAFFAR et al., entitled “PHYSICAL UPLINK SHARED CHANNEL REPETITIONS IN SUBBAND FULL DUPLEX OPERATIONS,” filed Mar. 27, 2025, assigned to the assignee hereof, and expressly incorporated herein.

### TECHNICAL FIELD

This disclosure relates generally to wireless communication, and more specifically to systems, devices, methods, and techniques associated with physical uplink shared channel (PUSCH) repetitions in subband full duplex (SBFD) operations.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include receiving control signaling that indicates a pattern of downlink symbols, uplink symbols, and flexible symbols across one or more slots, where the control signaling further indicates that a subset of the downlink symbols and a subset of the flexible symbols correspond to subband full duplex (SBFD) symbols, receiving a message that indicates a set of nominal repetitions of a physical uplink shared channel (PUSCH), where one or more nominal repetitions of the set of nominal repetitions span at least a portion of the uplink symbols, a portion of the flexible symbols, or both, and span at least a portion of the SBFD symbols across the one or more slots, and transmitting a set of actual repetitions of the PUSCH via the uplink symbols, the flexible symbols, the SBFD symbols, or a combination thereof, where the set of actual repetitions are identified from the set of nominal repetitions in accordance with valid symbol types.

A UE for wireless communications is described. The UE may include a processing system that includes processor circuitry and memory circuitry that stores code. The processing system may be configured to cause the UE to receive control signaling that indicates a pattern of downlink symbols, uplink symbols, and flexible symbols across one or more slots, where the control signaling further indicates that a subset of the downlink symbols and a subset of the flexible symbols correspond to SBFD symbols, receive a message that indicates a set of nominal repetitions of a PUSCH, where one or more nominal repetitions of the set of nominal repetitions span at least a portion of the uplink symbols, a portion of the flexible symbols, or both, and span at least a portion of the SBFD symbols across the one or more slots, and transmit a set of actual repetitions of the PUSCH via the uplink symbols, the flexible symbols, the SBFD symbols, or a combination thereof, where the set of actual repetitions are identified from the set of nominal repetitions in accordance with valid symbol types.

Another UE for wireless communications is described. The UE may include means for receiving control signaling that indicates a pattern of downlink symbols, uplink symbols, and flexible symbols across one or more slots, where the control signaling further indicates that a subset of the downlink symbols and a subset of the flexible symbols correspond to SBFD symbols, means for receiving a message that indicates a set of nominal repetitions of a PUSCH, where one or more nominal repetitions of the set of nominal repetitions span at least a portion of the uplink symbols, a portion of the flexible symbols, or both, and span at least a portion of the SBFD symbols across the one or more slots, and means for transmitting a set of actual repetitions of the PUSCH via the uplink symbols, the flexible symbols, the SBFD symbols, or a combination thereof, where the set of actual repetitions are identified from the set of nominal repetitions in accordance with valid symbol types.

A non-transitory computer-readable medium storing code for wireless communications is described. The code may include instructions executable by one or more processors to receive control signaling that indicates a pattern of downlink symbols, uplink symbols, and flexible symbols across one or more slots, where the control signaling further indicates that a subset of the downlink symbols and a subset of the flexible symbols correspond to SBFD symbols, receive a message that indicates a set of nominal repetitions of a PUSCH, where one or more nominal repetitions of the set of nominal repetitions span at least a portion of the uplink symbols, a portion of the flexible symbols, or both, and span at least a portion of the SBFD symbols across the one or more slots, and transmit a set of actual repetitions of the PUSCH via the uplink symbols, the flexible symbols, the SBFD symbols, or a combination thereof, where the set of actual repetitions are identified from the set of nominal repetitions in accordance with valid symbol types.

In some examples of the method, UEs, and non-transitory computer-readable medium described herein, the valid symbol types correspond to a symbol type of a first transmission occasion of the set of nominal repetitions in accordance with a configuration associated with the SBFD symbols, the valid symbol types correspond to a symbol type of a first transmission occasion the set of actual repetitions in accordance with the configuration, or the valid symbol types may be in accordance with an indication from a network entity.

In some examples of the method, UEs, and non-transitory computer-readable medium described herein, non-SBFD symbols and the SBFD symbols may be valid symbols in accordance with a configuration associated with the SBFD symbols and the non-SBFD symbols include the uplink symbols and a second subset of the flexible symbols.

In some examples of the method, UEs, and non-transitory computer-readable medium described herein, a first configuration and a second configuration associated with the SBFD symbols may be not applicable for transmission of the set of actual repetitions and the uplink symbols and the subset of the downlink symbols allocated as the SBFD symbols correspond to the valid symbol types.

In some examples of the method, UEs, and non-transitory computer-readable medium described herein, the subset of the downlink symbols indicated as the SBFD symbols may be valid symbols.

### BRIEF DESCRIPTION OF THE DRAWINGS

FIG. 1 shows an example of a wireless communications system.

FIG. 2 shows an example of a signaling diagram that supports physical uplink shared channel (PUSCH) repetitions in subband full duplex (SBFD) operations.

FIG. 3 shows an example of a resource diagram that supports PUSCH repetitions in SBFD operations.

FIG. 4 shows an example of a resource diagram that supports PUSCH repetitions in SBFD operations.

FIG. 5 shows an example of a resource diagram that supports PUSCH repetitions in SBFD operations.

FIG. 6 shows an example of a resource diagram that supports PUSCH repetitions in SBFD operations.

FIG. 7 shows an example of a resource diagram that supports PUSCH repetitions in SBFD operations.

FIG. 8 shows an example of a resource diagram that supports PUSCH repetitions in SBFD operations.

FIG. 9 shows an example of a resource diagram that supports PUSCH repetitions in SBFD operations.

FIG. 10 shows an example of a resource diagram that supports PUSCH repetitions in SBFD operations.

FIG. 11 shows an example of a process flow that supports PUSCH repetitions in SBFD operations.

FIG. 12 shows a block diagram of a processing system that supports PUSCH repetitions in SBFD operations.

FIG. 13 shows a diagram of a system including a device that supports PUSCH repetitions in SBFD operations.

FIG. 14 shows a flowchart illustrating methods that support PUSCH repetitions in SBFD operations.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communications systems, a network entity may schedule a user equipment (UE) to perform physical uplink shared channel (PUSCH) repetitions, which may increase the reliability of the PUSCH transmission. In such cases, the UE may operate according to PUSCH repetition type B, in which one or more nominal repetitions of the PUSCH may be scheduled within slots, across slot boundaries, or both. For example, a UE may receive a message that indicates for the UE to perform the PUSCH repetition, where the message may include a quantity of nominal repetitions (e.g., K repetitions), a quantity of symbols allocated for each nominal repetition (e.g., a length of each nominal repetition, L), and a starting symbol of a first nominal repetition of the quantity of nominal repetitions (e.g., starting symbol, S). The UE may identify a transmission occasion associated with each nominal repetition according to the message, where one or more nominal repetitions may span multiple slots. In this way, a nominal repetition may correspond to a PUSCH transmission occasion that is scheduled via the values K, L, and S.

The UE may segment each nominal repetition into one or more actual repetitions (e.g., repetitions of the PUSCH transmission that are transmitted after segmentation is accounted for). In one case, if a first portion of a nominal repetition spans symbols of a first slot and a second portion of the nominal repetition spans symbols of a second slot, the UE may segment the nominal repetition into a first actual repetition (e.g., transmitted via the symbols of the first slot) and a second actual repetition (e.g., transmitted via the symbols of the second slot). In another case, the UE may identify one or more invalid symbols, where, if a nominal repetition spans the one or more invalid symbols, the UE may segment the nominal repetition into one or more actual repetitions around the invalid symbols. In such cases, the one or more invalid symbols may include downlink symbols, symbols allocated for synchronization signal blocks (SSBs), or symbols identified according to a pattern (e.g., InvalidSymbolPattern), among other examples.

In some cases, the UE may support SBFD operations. In the SBFD operations, a network entity may allocate one or more downlink symbols (or flexible symbols) as SBFD symbols, where an SBFD symbol may include both an uplink subband and a downlink subband. In this way, the UE may receive downlink communications via the downlink subband and transmit uplink communications via the uplink subband at a same time (e.g., within a same symbol), thereby improving communication capacity and increasing efficiency, among other advantages. In such cases, however, because SBFD symbols are allocated in downlink symbols, such SBFD symbols may be considered invalid symbols during PUSCH repetition operations, which may prohibit such SBFD symbols from being used during PUSCH repetition type B transmissions. Prohibiting the use of SBFD symbols during PUSCH repetitions may lead to decreased communication capacity and inefficiencies for the PUSCH repetitions. Thus, techniques may be desired to enable PUSCH repetitions across the SBFD symbols.

Aspects of the subject matter described in this disclosure relate to performing PUSCH repetitions in conjunction with communicating via SBFD symbols. Specific aspects of the subject matter described herein may enable a UE to transmit PUSCH repetitions via SBFD symbols. For example, the UE may receive control signaling that indicates a pattern of downlink symbols, uplink symbols, and flexible symbols across one or more slots. The UE may also receive, via the control signaling, an indication that a subset of the downlink symbols and a subset of the flexible symbols correspond to SBFD symbols. The UE may also receive a message that indicates a set of nominal repetitions of a PUSCH (e.g., the message indicates K, S, and L), where one or more nominal repetitions of the set span at least a portion of the uplink symbols, span a portion of the flexible symbols, or both, and at least a portion of the SBFD symbols.

In response to receiving the control signaling and the message, the UE may identify a set of actual repetitions of the PUSCH from the set of nominal repetitions according to valid symbol types. In some examples, the valid symbol types for the PUSCH repetitions may correspond to either the non-SBFD symbols (e.g., uplink symbols or a subset of flexible symbols not allocated as SBFD symbols) or the SBFD symbols (but not both), where the UE may determine the valid symbol type according to a symbol type of a first transmission occasion of the set of nominal repetitions, according to a symbol type of a first transmission occasion of the set of actual repetitions, or according to an indication from the network entity. In some other examples, the valid symbol types for the PUSCH repetitions may correspond to both the non-SBFD symbols and the SBFD symbols. According to identifying the set of actual repetitions, the UE may transmit the set of actual repetitions of the PUSCH.

Particular aspects of the subject matter described in this disclosure can be implemented to realize one or more of the following potential advantages. In some examples, by enabling the UE to transmit PUSCH repetitions via SBFD symbols, the described techniques can be used to increase the performance of PUSCH repetitions, improve communication capacity, improve uplink coverage, and increase efficiencies during PUSCH repetitions. Further, by providing one or more rules associated with identifying valid symbols for the PUSCH repetitions and SBFD operations, the UE and the network entity may improve coordination, thereby reducing communication mismatches and improving overall system functionality.

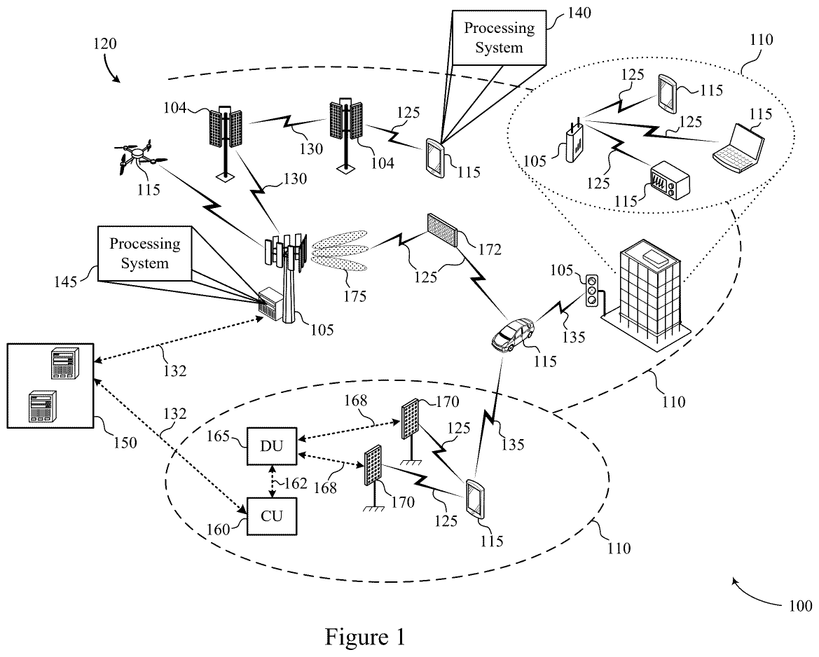

FIG. 1 shows an example of a wireless communications system 100. The wireless communications system 100 includes a core network 150 and a RAN 120 that support communication with one or more devices, such as UEs 115. A RAN 120 may include one or more network entities 105 configured to support wireless communication with the UEs 115.

The wireless communications system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communications system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communications system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communications system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communications system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communications system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communications system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHZ), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a SBFD configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communications system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a PUSCH for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communications system 100 may be configured to support one or more aspects of the described techniques for physical uplink shared channel repetitions in subband full duplex operations. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support PUSCH repetitions in SBFD symbols.

For example, the UE 115 may receive control signaling that indicates a pattern of downlink symbols, uplink symbols, and flexible symbols across one or more slots. The UE 115 may also receive, via the control signaling, an indication that a subset of the downlink symbols and a subset of the flexible symbols correspond to SBFD symbols. The UE 115 may also receive a message that indicates a set of nominal repetitions of a PUSCH, where one or more nominal repetitions of the set span at least a portion of the uplink symbols and at least a portion of the SBFD symbols.

In response to receiving the control signaling and the message, the UE 115 may identify a set of actual repetitions of the PUSCH from the set of nominal repetitions according to valid symbol types. In some examples, the valid symbol types for the PUSCH repetitions may correspond to either the non-SBFD symbols or the SBFD symbols (but not both), where the UE 115 may determine the valid symbol type according to a symbol type of a first transmission occasion of the set of nominal repetitions, according to a symbol type of a first transmission occasion of the set of actual repetitions, or according to an indication from the network entity. In some other examples, the valid symbol types for the PUSCH repetitions may correspond to both the non-SBFD symbols and the SBFD symbols. According to identifying the set of actual repetitions, the UE 115 may transmit the set of actual repetitions of the PUSCH.

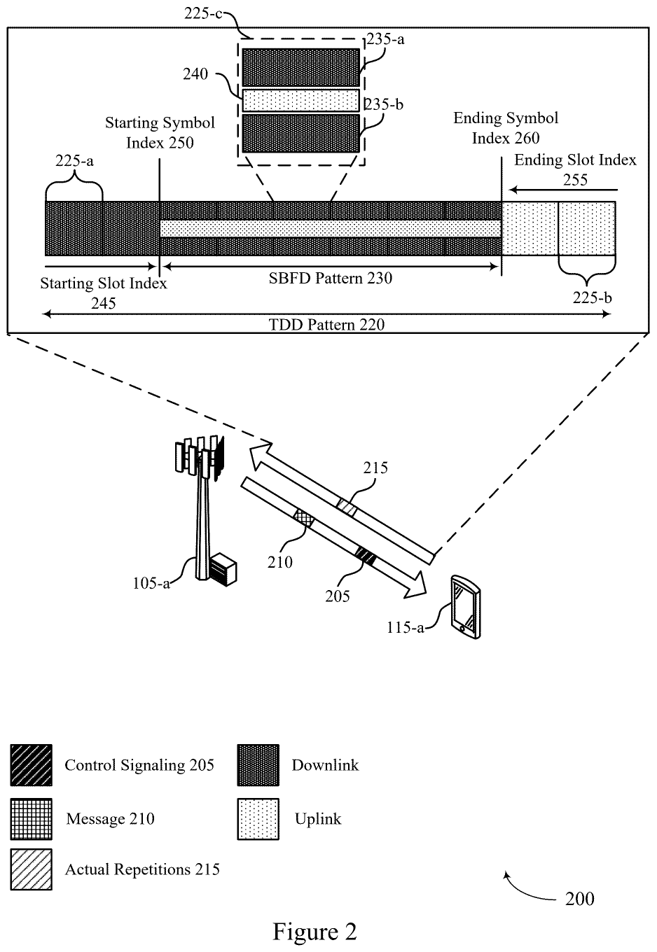

FIG. 2 shows an example of a signaling diagram 200 that supports PUSCH repetitions in SBFD operations. Aspects of the signaling diagram 200 may implement, or be implemented by, aspects of the wireless communications system 100. For example, the signaling diagram 200 may include a UE 115-a and a network entity 105-a, which may be examples of a UE 115 and a network entity 105, as described herein. The techniques described in the context of the signaling diagram 200 may enable the UE 115-a to perform PUSCH repetitions via SBFD symbols.

In some cases, the UE 115-a may support two types of PUSCH repetition. In PUSCH repetition type A (e.g., a first type), the UE 115-a may receive an indication of a quantity of repetitions (e.g., K>1), where each repetition is transmitted via a respective slot (e.g., K repetitions transmitted in K consecutive slots). As part of PUSCH repetition type A, the UE 115-a may apply a same slot length indicator value (SLIV) across the K consecutive slots.

In PUSCH repetition type B (e.g., a second type), each nominal PUSCH repetition may be within a slot, span multiple slots, or cross slot boundaries, among other examples. Further, as part of PUSCH repetition type B, the UE 115-a may receive a dynamic indication of a quantity of repetitions (e.g., K), perform inter-nominal PUSCH frequency hopping, implement an uplink and downlink interaction, and/or receive a SLIV dedicated for the second type of PUSCH repetitions, among other examples. For example, in PUSCH repetition type B, the UE 115-a may transmit K nominal repetitions, each with a nominal (e.g., symbol) length of L, back-to-back starting from a symbol S, where S and L are provided by the SLIV.

In PUSCH repetition type B, the UE 115-a may determine a transport block size (TBS) for a first nominal repetition according to the nominal length (e.g., L). In some cases, the nominal length of the repetitions and the starting symbol (e.g., S+L) may be greater than 14 symbols, thereby enabling the nominal repetitions to cross slot boundaries. As an illustrative example, the UE 115-a may receive an indication of four nominal repetitions (e.g., K=4), receive an indication that each nominal repetition spans seven symbols (e.g., L=7), and receive an indication that a first nominal repetition of the four nominal repetition starts at symbol S. As described herein, a nominal repetition corresponds to PUSCH transmissions occasions indicated by K, S, and L.

In some cases, as part of PUSCH repetition type B, the UE 115-a may segment a nominal repetition according to invalid symbol types, according to slot boundaries, or both. That is, the UE 115-a may segment (e.g., split or divide) a nominal repetition around a slot border, around semi-static downlink symbols, or according to a pattern indicated from the network entity (e.g., via the InvalidSymbolPattern parameter).

To facilitate such segmentation for PUSCH repetition type B, the UE 115-a may determine invalid symbols for PUSCH repetition type B transmissions according to one or more rules. In a first rule, a symbol that is indicated as downlink via tdd-UL-DL-ConfigurationCommon or tdd-UL-DL-ConfigurationDedicated may be considered as an invalid symbol for PUSCH repetition type B transmission. In a second rule, for operating in unpaired spectrum, symbols indicated by ssb-PositionInBurst in SIB1 or ssb-PositionInBurst in ServingCellConfigCommon for reception of synchronization signal/physical broadcast channel (SS/PBCH) blocks (SSBs) may be considered as invalid symbols for PUSCH repetition type B transmission. In a third rule, for operations in unpaired spectrum, if numberOfInvalidSymbolsForDL-UL-Switching is configured, numberOfInvalidSymbolsForDL-UL-Switching symbols after the last symbol that is indicated as downlink in each consecutive set of all symbols that are indicated as downlink by tdd-UL-DL-ConfigurationCommon or tdd-UL-DL-ConfigurationDedicated are considered invalid symbol(s) for PUSCH repetition type B transmission. The symbol(s) given by numberOfInvalidSymbolsForDL-UL-Switching may be defined using the reference subcarrier spacing (SCS) configuration referenceSubcarrierSpacing provided in tdd-UL-DL-ConfigurationCommon.

As an illustrative example of such segmentation, if a single nominal repetition spans a slot and the slot is formatted according to the following pattern: UUUUDDUUU, where U represents an uplink symbol and D represents a downlink symbol, the UE 115-a may segment the nominal repetition into two actual repetitions around the two downlink symbols within the slot. Accordingly, the UE 115-a may transmit a first actual repetition of the PUSCH (e.g., a PUSCH repetition type B transmission) via the first four uplink symbols and transmit a second actual repetition via the last three uplink symbols, where the first and second actual repetition correspond to (e.g., are segmented from) the single nominal repetition.

The UE 115-a may also perform frequency hopping as part of PUSCH repetition type B. For example, the UE 115-a may support inter-slot frequency hopping (e.g., transmitting a first set of repetitions via a first RBs and first slot and transmitting a second set of repetitions via second RB and a second slot), inter-nominal frequency hopping (e.g., transmitting a first actual repetition corresponding to a first nominal repetition via a first RB and transmitting a second actual repetition corresponding to a second nominal repetition via a second RB).

The UE 115-a may receive an indication of the frequency hopping scheme via the RRC parameter frequencyHopping-ForDCIFormat0_1 or by frequencyHopping-ForDCIFormat0_2 configured in pusch-Config for scheduling and/or activation by DCI format 0_1 and DCI format 0_2, respectively. Further, for type 1 configured grant PUSCH repetitions, the UE 115-a may receive the frequency hopping scheme via frequencyHopping-PUSCHRepTypeB provided in configuredGrantConfig. In such cases, unlike PUSCH repetition Type A, for PUSCH repetition type B, type 2 configured grant PUSCH transmissions may follow the same frequency hopping scheme that is associated with activation DCI. Further, if the various frequency hopping scheme parameters are absent (e.g., Null or not configured), frequency hopping may not be configured.

In case of inter-repetition frequency hopping, the starting RB (e.g., RBₛₜₐᵣₜ(n)) for an actual repetition within the n^{th} nominal repetition, is given by Equation 1:

$$R {B}_{start} ( n ) = \{ \begin{matrix}{RB}_{start} , n mod 2 = 0 \\ ( {RB}_{start} + {RB}_{offset} ) mod {N}_{BWp}^{size} , n mod 2 = 1\end{matrix} \qquad ( 1 )$$

RBₛₜₐᵣₜ may be a staring resource block index indicated via the message scheduling the PUSCH repetitions, RB_{offset} may be a RB offset indicated via the message scheduling the PUSCH repetitions, and

$${N}_{BWp}^{s i z e}$$

may be the size of the uplink BWP.

In some cases, the UE 115-a may support SBFD operations across one or more slots. The network entity 105-a may configure one or more downlink symbols, one or more flexible symbols, or both as SBFD symbols. Accordingly, non-SBFD symbols may correspond to uplink symbols, unassigned flexible symbols, and/or unassigned downlink symbols.

For uplink transmissions and downlink receptions across SBFD symbols and non-SBFD symbols in different slots (e.g., each transmission and/or reception within a slot may have either all SBFD or all non-SBFD symbols) for an SBFD aware UE 115-a, the SBFD-aware UE 115-a may be provided with one of two configurations. In a first SBFD configuration (e.g., configuration 1), the transmissions and/or receptions are restricted to SBFD symbols or non-SBFD symbols. That is, in the first SBFD configuration for SBFD operations, the UE 115-a may communicate either via SBFD symbols or non-SBFD symbols (e.g., uplink symbols, downlink symbols, and flexible symbols). In a second SBFD configuration (e.g., configuration 2), the transmissions and/or receptions can be in SBFD symbols and non-SBFD symbols. That is, in the second SBFD configuration for SBFD operations, the UE 115-a may communicate via both SBFD and non-SBFD symbols.

The UE 115-a may be configured to operate according to the second SBFD configuration on per uplink BWP, per downlink BWP, or both. Accordingly, the configuration applicable to the downlink BWP may apply to PDSCH receptions within the downlink BWP. That is, the first SBFD configuration and the second SBFD configuration may apply to PDSCH receptions within the downlink BWP. The configuration applicable to the uplink BWP may apply to both PUCCH and PUSCH transmissions within the uplink BWP. Additionally, the UE 115-a may apply the first SBFD configuration for sounding reference signal (SRS) transmissions and may refrain from applying the second SBFD configuration for such SRS transmissions.

In some cases, the UE 115-a may operate according to the first SBFD configuration by default, while support for second SBFD configuration may be based on (e.g., subject to) a capability of the UE 115-a. In some other cases, the UE 115-a may first be semi-statically configured to operate according to the first SBFD configuration (or the second SBFD configuration) per uplink BWP. In response to being configured to operate according to the first SBFD configuration, the UE 115-a may identify a valid symbol type for the first SBFD configuration (e.g., whether SBFD or non-SBFD symbols are configured for communication) according to a type of the PUSCH transmission. In some other cases, the first SBFD configuration and the second SBFD configuration may not be applicable to PUSCH repetition type B.

If the type of PUSCH transmission corresponds to a configured grant PUSCH type 1, the UE 115-a may receive an RRC parameter (e.g., rrc-ConfiguredUplinkGrant in ConfiguredGrantConfig) that indicates the valid symbol type, semi-statically (e.g., indicates whether SBFD symbols or non-SBFD symbols are configured for communications). In some scenarios, the RRC parameter may not be configured and the UE 115-a may follow a default rule (e.g., defined in a standards specification) to indicate the valid symbol type as SBFD symbols or non-SBFD symbols. In some other scenarios, the presence of the RRC parameter may be a mandatory configuration, such that the UE 115-a may not expect the absence of the RRC parameter.

If the type of PUSCH transmission corresponds to configured grant PUSCH type 2, the UE 115-a may determine the valid symbol type according to a symbol type of the first transmission occasion of the configured grant. For example, if the first PUSCH transmission occasion of the configured PUSCH transmission occasion includes SBFD symbols, then UE 115-a determines that SBFD symbols are the valid symbol types and that non-SBFD symbols (e.g., downlink, uplink, and flexible symbols) are invalid symbol types.

If the type of PUSCH transmission corresponds to dynamic grant PUSCH repetition or multiple PUSCHs scheduled via a single DCI, the UE 115-a may determine the valid symbol type according to a symbol type of the first transmission occasion. For example, if the first PUSCH transmission occasion of the multiple PUSCHs scheduled by the single DCI includes non-SBFD symbols, then UE 115-a determines that non-SBFD symbols are the valid symbol types and that SBFD symbols are invalid symbol types.

In response to identifying the valid symbol type for the first SBFD configuration associated with the SBFD operation, the UE 115-a may postpone or drop the transmissions that span invalid symbol types. In one case, for uplink transmissions and downlink receptions across SBFD symbols and non-SBFD symbols in different slots (e.g., each transmission and/or reception within a slot has either all SBFD or all non-SBFD symbols) with the first Configuration and for PUSCH repetition type A with available slot counting, aperiodic SRS transmissions with available slot counting, transport block over multiple slots (TBoMS), and PUCCH repetitions, the UE 115-a may postpone transmissions in the invalid symbol type.

In another case, for uplink transmissions and downlink receptions across SBFD symbols and non-SBFD symbols in different slots (e.g., each transmission and/or reception within a slot has either all SBFD or all non-SBFD symbols) with the first Configuration and for configured grant PUSCH with neither TBoMS nor PUSCH repetition type A with available slot counting, and semi-persistent scheduled (SPS) PDSCH, periodic and/or semi-persistent SRS, periodic and/or semi-persistent channel state information reference signals (CSI-RS), periodic and/or semi-persistent PUCCH, semi-persistent channel state information on PUSCH, PUSCH repetition type A without available slot counting, multi-PUSCH and/or PDSCH scheduled by a single DCI, and PDSCH repetitions, the UE 115-a may drop transmissions and/or receptions in the invalid symbol type.

As described herein, if the UE 115-a performs PUSCH repetition type B, the UE 115-a may determine various invalid symbol types, such as downlink symbols and SSB symbols. Such determination, however, may be ambiguous for a UE 115-a while operating according to the first SBFD configuration and the second SBFD configuration associated with SBFD operations. That is, because SBFD symbols are allocated in downlink symbols, such SBFD symbols may be considered invalid symbols during PUSCH repetition operations, which may prohibit such SBFD symbols from being used during PUSCH type B repetitions. Prohibiting the use of SBFD symbols during PUSCH repetitions may lead to decreased communication capacity and inefficiencies for the PUSCH repetitions. Further, if the UE 115-a supports PUSCH repetition type B and SBFD operations, the UE 115-a may not be able to determine invalid symbol types for PUSCH repetition type B procedures when operating according to the first SBFD configuration or the second SBFD configuration.

Thus, techniques may be desired in order to determine whether the first SBFD configuration and the second SBFD configuration are applicable to PUSCH repetition type B, determine valid symbol types for PUSCH repetitions while operating according to the first SBFD configuration, determine frequency hopping during PUSCH repetition type B and SBFD operations, and determine whether symbols indicated as downlinks symbols in a reference cell are to be considered invalid symbols for PUSCH repetition type B during SBFD operations.

The techniques described herein enable the UE 115-a to support type B PUSCH repetitions while also supporting SBFD operations. For example, the UE 115-a may receive control signaling 205 (e.g., RRC signaling or system information block 1 (SIB1) signaling) that indicates a TDD pattern 220 (e.g., tdd-UL-DL-ConfigurationCommon or tdd-UL-DL-ConfigurationDedicated) of downlink symbols 225-a, uplink symbols 225-b, and flexible symbols (not shown) across one or more slots.

The UE 115-a may also receive, via the control signaling 205, an indication of an SBFD pattern 230 of SBFD symbols 225-c, where each SBFD symbol 225-c may include one or more downlink subbands 235 (e.g., illustrated as a downlink subband 235-a and a downlink subband 235-b) and one or more uplink subbands 240. In this way, the UE 115-a to transmit uplink messages via the uplink subband 240 and receive downlink messages via the downlink subbands 235 within a same symbol.

As described herein, the network entity 105-a allocate the SBFD pattern 230 by indicating that a subset of the downlink symbols 225-a (e.g., and/or a subset of the flexible symbols) correspond to SBFD symbols 225-c. To indicate a start of the SBFD pattern 230, the network entity 105-a may transmit, via the control signaling 205, a starting slot index 245 and a starting symbol index 250 within the starting slot of the TDD pattern 220. To indicate an end of the SBFD pattern 230, the network entity 105-a may transmit, via the control signaling 205, an ending slot index 255 and an ending symbol index 260. Accordingly, the downlink symbols 225-a and/or the flexible symbols between the starting slot index 245 and the starting symbol index 250 and the ending slot index 255 and the ending symbol index 260 may be allocated as SBFD symbols 225-c.

In such examples, the UE 115-a may receive a message 210 that indicates a set of nominal repetitions of a PUSCH (e.g., type B PUSCH repetition transmission occasions), where one or more nominal repetitions of the set span at least a portion of the uplink symbols 225-b, span at least a portion of the flexible symbols, or both, and span at least a portion of the SBFD symbols 225-c. As described herein, the message 210 may indicate a quantity of nominal repetitions (e.g., K), a quantity of symbols per nominal repetition (e.g., nominal length, L), and indicate a starting symbol (e.g., S). A nominal repetition may be, or correspond to, the transmission occasion (e.g., set of symbols) of a PUSCH repetitions and may be identified from K, L, and S.

In response to receiving the control signaling 205 and the message 210, the UE 115-a may identify a set of actual repetitions 215 of the PUSCH (e.g., transmitted PUSCH type B repetitions) from the set of nominal repetitions according to whether first configuration is configured, according to whether the second configuration is configured, and according to valid symbol types, among other examples. That is, to identify the set of actual repetitions 215 from the set of nominal repetitions, the UE 115-a may identify valid symbol types and invalid symbol types according to one or more rules, where such valid and invalid symbol types may be based on whether the UE 115-a is operating according to the first SBFD configuration or the second SBFD configuration. In response to identifying the valid symbol types and the invalid symbol types, the UE 115-a may determine the set of actual repetitions 215.

In some examples, the first SBFD configuration and the second SFBD configuration may not be applicable for PUSCH type B repetition operations. That is, if the PUSCH repetition type B is activated at the UE 115-a, the UE 115-a may not be configured with the first SBFD configuration nor the second SBFD configuration. In such examples, the UE 115-a may determine the invalid symbol types for the set of actual repetitions 215 according to one or more legacy rules, where the SBFD symbols 225-c configured in the downlink symbols 225-a and/or the flexible symbols may be considered valid symbols.

In some other examples, the first SBFD configuration may be applicable for PUSCH type B repetitions, while the second SBFD configuration may not be applicable for the PUSCH type B repetitions. That is, if the PUSCH repetition type B is activated at the UE 115-a, the UE 115-a may be configured to operate according to the first SBFD configuration (e.g., PUSCH transmissions occur in either SBFD or non-SBFD symbols).

Additionally, or alternatively, the second SBFD configuration may be applicable for PUSCH type B repetitions, while the first SBFD configuration may not be applicable for the PUSCH type B repetitions. That is, if the PUSCH repetition type B is activated at the UE 115-a, the UE 115-a may be configured to operate according to the second SBFD configuration (e.g., PUSCH transmissions occur in both SBFD and non-SBFD symbols).

In some examples, both the first SBFD configuration and the second SBFD configuration may be applicable for PUSCH type B repetition. That is, if the PUSCH repetition type B is activated at the UE 115-a, the UE 115-a may be configured to operate according to the first SBFD configuration or the second SBFD configuration. Accordingly, the UE 115-a may proceed to determine the valid and invalid symbols for the set of actual repetitions 215 (e.g., PUSCH type B repetitions) according to the per uplink BWP configuration (e.g., according to whether the uplink BWP is associated with the first or second SBFD configuration).

If the UE 115-a is configured with the first SBFD configuration for uplink transmissions in an uplink BWP, the UE 115-a may determine the valid symbol types for the set of actual repetitions 215 according to a symbol type of a first transmission occasion of the set of nominal repetitions (e.g., such a determination may be valid for configured grant PUSCH type 2 transmissions and dynamic grant PUSCHs). As an illustrative example, if the first transmission occasion (e.g., a first set of symbols) associated with a first nominal repetition includes SBFD symbols 225-c, the UE 115-a may determine that the valid symbols include the SBFD symbols 225-c and that the non-SBFD symbols (e.g., uplink symbols 225-b and flexible symbols) are invalid symbols. In such examples, the UE 115-a may not expect that the first nominal transmission occasion to have mixed SBFD and non-SBFD symbol types.

In some other examples, if the UE 115-a is configured with the first SBFD configuration for uplink transmissions in an uplink BWP, the UE 115-a may determine the valid symbol type for the set of actual repetitions 215 according to a symbol type of a first transmission occasion of the set of actual repetitions 215 (e.g., such a determination may be valid for configured grant PUSCH type 2 transmissions and dynamic grant PUSCHs). As an illustrative example, if the first transmission occasion (e.g., a first set of symbols) associated with a first actual repetition 215 include non-SBFD symbols (e.g., uplink symbols 225-b and/or flexible symbols), the UE 115-a may determine that the valid symbols include the non-SBFD symbols and that the SBFD symbols 225-c are invalid symbols. In such examples, the UE 115-a may not expect that the first actual transmission occasion to have mixed SBFD and non-SBFD symbol types.

In some examples, if the UE 115-a is configured with the first SBFD configuration for uplink transmissions in an uplink BWP, the UE 115-a may determine the valid symbol type for the set of actual repetitions 215 according to an indication from the network entity 105-a (e.g., where such a determination may be valid for configured grant PUSCH type 1 transmissions per CG-PUSCH-Config). As an illustrative example, if the set of actual repetitions 215 correspond to configured grant PUSCH type 1 repetitions and the UE 115-a is configured with the first SBFD configuration, the network entity 105-a may indicate, via the control signaling 205 (e.g., RRC signaling), an indication of the valid symbol type (e.g., either SBFD or non-SBFD symbols).

In one example, the indication of the valid symbol type may be configured by the network entity 105-a. In another example, if the valid symbol type is not configured by the network entity 105-a, the UE 115-a may assume that the valid symbol type corresponds to the SBFD symbols 225-c. Alternatively, if the valid symbol type is not configured by the network entity 105-a, the UE 115-a may assume the valid symbol type corresponds to non-SBFD symbols.

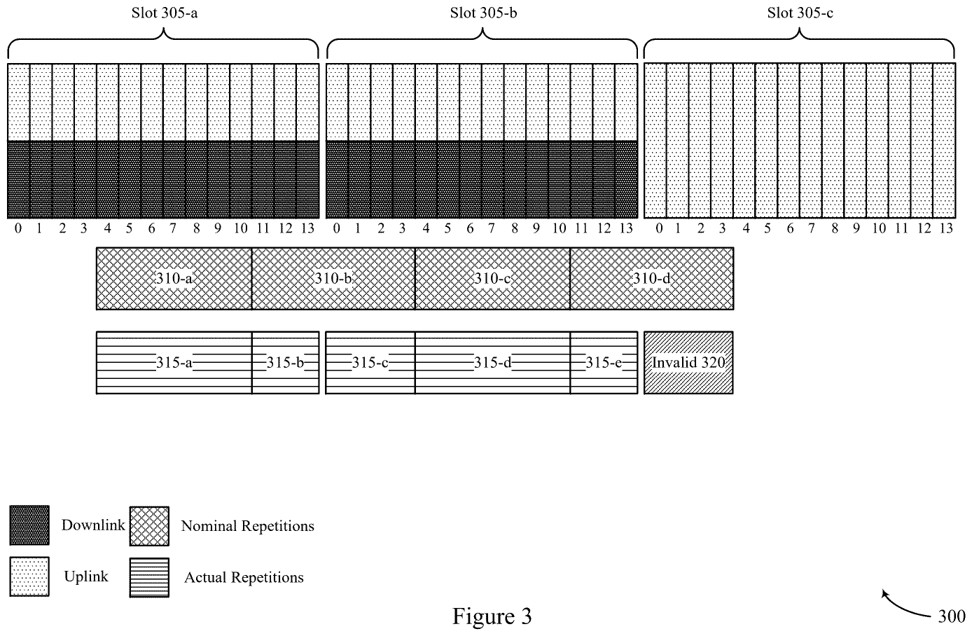

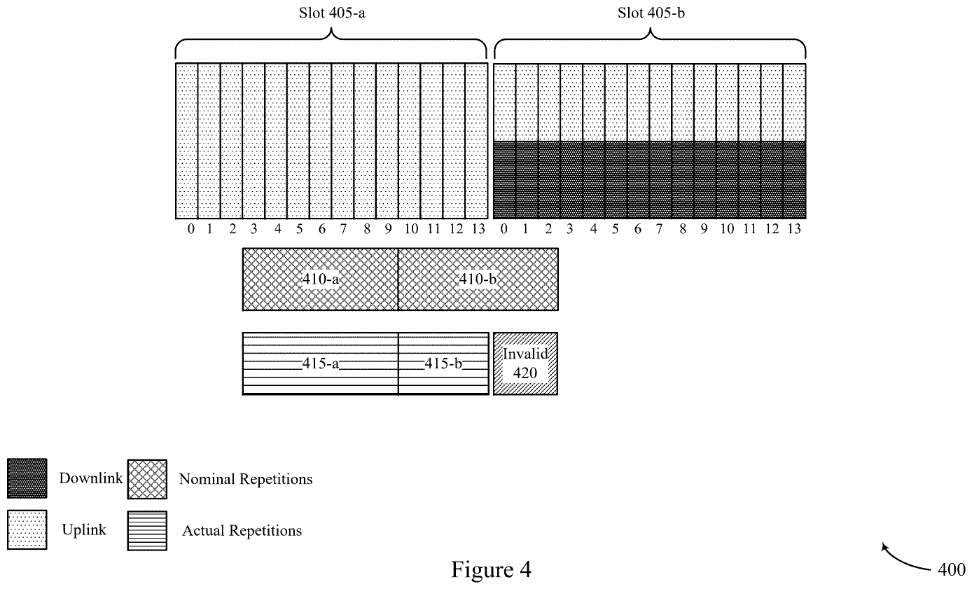

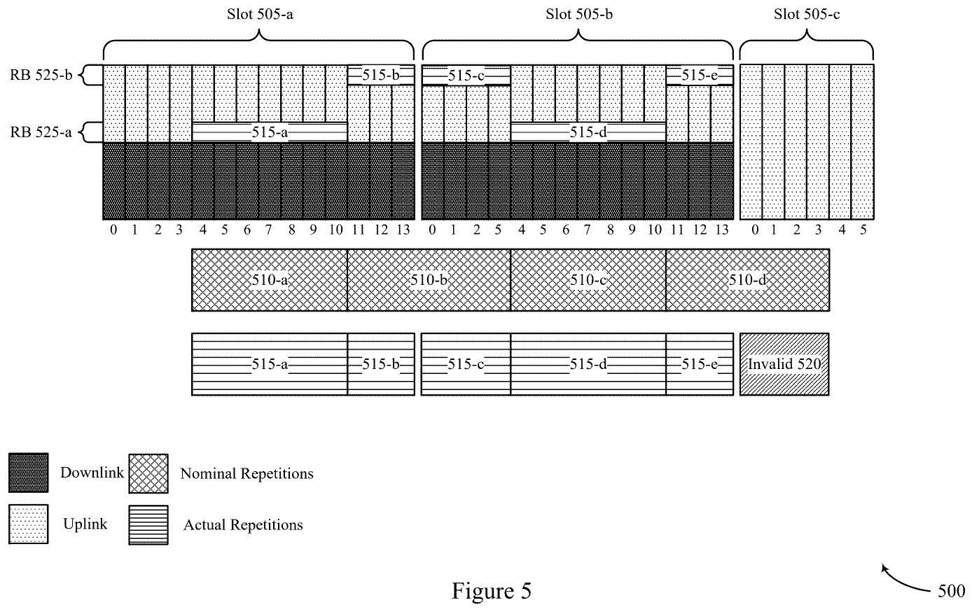

Techniques to determine the set of actual repetitions 215 while operating according to the first SBFD configuration may be further described herein with reference to FIGS. 3-4. Techniques for performing frequency hopping for the set of actual repetitions 215 while operating according to the first SBFD configuration may be further described herein with reference to FIG. 5.

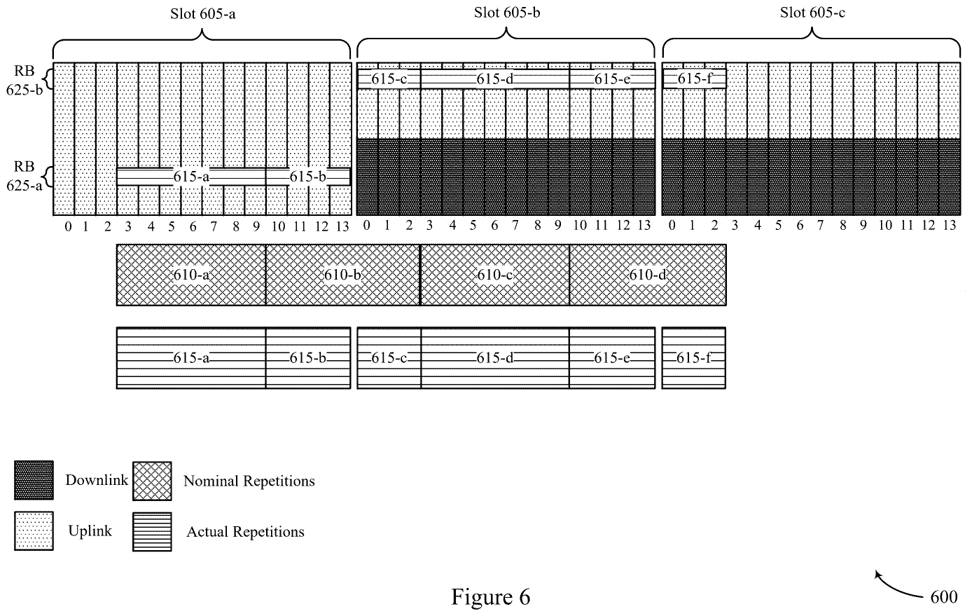

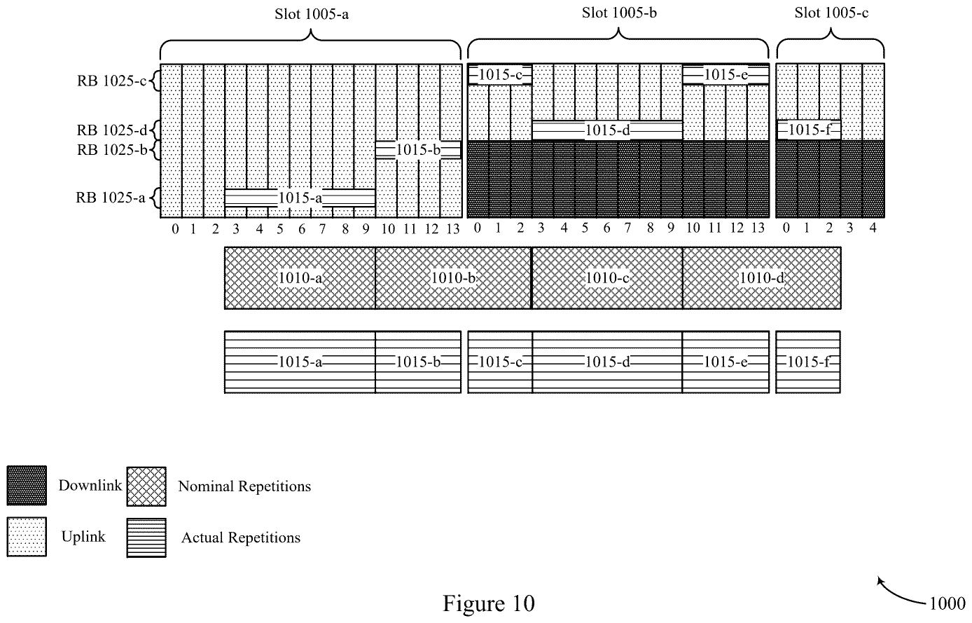

If the UE 115-a is configured with the second SBFD configuration for uplink transmissions in an uplink BWP, the UE 115-a may determine that the valid symbol types for the set of actual repetitions 215 correspond to both the non-SBFD symbols (e.g., uplink and flexible symbols) and the SBFD symbols 225-c. Techniques to determine the set of actual repetitions 215 while operating according to the second SBFD configuration may be further described herein with reference to FIGS. 6-9. Techniques for performing frequency hopping for set of actual repetitions 215 while operating according to the second SBFD configuration may be further described herein with reference to FIG. 10.

In some cases, if the UE 115-a is configured with multiple serving cells within a cell group and is provided with directionalCollisionHandling-r16=‘enabled’ for a set of serving cell(s) among the multiple serving cells, and if the UE 115-a indicates support of half-DuplexTDD-CA-SameSCS-r16 capability, and if the UE 115-a is not configured to monitor PDCCH for detection of DCI format 2-0 on any of the multiple serving cells, then a symbol indicated to the UE 115-a for reception of SS/PBCH blocks in a first cell of the multiple serving cells by ssb-PositionInBurst in SIB1, or by SSB-PositionInBurst in ServingCellConfigCommon, or by NonCellDefiningSSB, or by SSB-PositionInBurst in SSB-MTC-AdditionalPCI associated to physical cell ID with active TCI states for PDCCH or PDSCH, or for a set of symbols of a slot corresponding to SS/PBCH blocks configured for L1 beam measurement/reporting is considered as an invalid symbol for PUSCH repetition type B transmission in any of the multiple serving cells if the UE is not capable of simultaneous transmission and reception as indicted by simultaneousRxTxInterBandCA among the multiple serving cells, and any one of the cells corresponding to the same band as the first cell, irrespective of any capability indicated by simultaneousRxTxInterBandCA, and a symbol is considered as an invalid symbol in another cell among the set of serving cell(s) provided with directionalCollisionHandling-r16 for PUSCH repetition type B transmission with Type 1 or Type 2 configured grant except for the first type 2 PUSCH transmission (including all repetitions) after activation if the symbol is indicated as downlink by tdd-UL-DL-ConfigurationCommon or tdd-UL-DL-ConfigurationDedicated on the reference cell, or the UE is configured by higher layers to receive PDCCH, PDSCH, or CSI-RS on the reference cell in the symbol.

In accordance with the techniques described herein, a symbol configured as downlink in a reference cell and is indicated as an SBFD symbol 225-c may be a valid symbol for PUSCH type B repetitions. That is, if the UE 115-a is configured with multiple cells, and a downlink symbol 225-a indicated on a reference cell of the multiple cells is configured as an SBFD symbol 225-c (e.g., via the SBFD pattern 230), then the UE 115-a may consider the SBFD symbol 225-c on the reference cell and the corresponding symbols on each of the other cells of the multiple cells to be valid symbols.

According to identifying the set of actual repetitions 215, the UE 115-a may transmit the set of actual repetitions 215 of the PUSCH (e.g., transmit the PUSCH repetition type B transmissions).

FIG. 3 shows an example of a resource diagram 300 that supports PUSCH repetitions in SBFD operations. Aspects of the resource diagram 300 may implement, or be implemented by, aspects of the wireless communications system 100 and the signaling diagram 200. For example, the resource diagram 300 may be implemented by a UE 115, as described herein. Techniques described in the context of the resource diagram 300 may enable the UE 115 to identify the actual repetitions 315 from the nominal repetitions 310 while operating according to the first SBFD configuration.

For example, as described herein with reference to FIG. 2, the UE 115 may receive control signaling that indicates a pattern of downlink symbols, flexible symbols, and uplink symbols across one or more slots, where the control signaling further indicates that a subset of the downlink symbols, a subset of the uplink symbols, or both correspond to SFBD symbols. As illustrated in the resource diagram 300, the control signaling may indicate that symbols 0-13 of slots 305-a and 305-b correspond to SBFD symbols, while symbols 0-13 of slot 305-c correspond to uplink symbols (e.g., non-SBFD symbols).

In some examples, the UE 115 may be configured to operate according to the first SBFD configuration for the SBFD symbols in the slots 305-a and 305-b. Additionally, the UE 115 may receive a message that indicates the nominal repetitions 310-a, 310-b, 310-c, and 310-d (e.g., the message indicates K=4, L=7, and S=4) for the PUSCH repetition type B operations.

In response to receiving the message, the UE 115 may determine the actual repetitions 315, such as the actual repetitions 315-a, 315-b, 315-c, 315-d, and 315-e, from the nominal repetitions 310 according to valid symbols and invalid symbols, according to slot boundaries, or both.

As described herein with reference to FIG. 2, in some examples, the UE 115 may determine the valid symbols according to the symbol type of the first transmission occasion of the first nominal repetition (e.g., the nominal repetition 310-a). In such examples, the UE 115 may determine that the valid symbol type corresponds to the SBFD symbols due to symbols 4-10 corresponding to the nominal repetition 310-a being SBFD symbols. As such, the UE 115 may determine that the invalid symbol type corresponds to the non-SBFD symbols (e.g., the uplink symbols and the subset of downlink and flexible symbols not assigned to SBFD symbols).

In some other examples, the UE 115 may determine the valid symbols according to the symbol type of the first transmission occasion of the first actual repetition (e.g., the actual repetition 315-a). In such examples, the UE 115 may determine that the valid symbol type corresponds to the SBFD symbols due to symbols 4-10 corresponding to the actual repetition 315-a being SBFD symbols. As such, the UE 115 may determine that the invalid symbol type corresponds to the non-SBFD symbols (e.g., the uplink symbols and the subset of downlink and flexible symbols not assigned to SBFD symbols).

In some other examples, if the PUSCH transmissions correspond to configured grant type 1 PUSCH transmissions, the UE 115 may determine the valid symbol type according to an indication from a network entity 105. In such examples, the UE 115 may receive an indication that the valid symbol type corresponds to a SBFD symbol.

In response to determining the SBFD symbols correspond to the valid symbol type and in accordance with operating in the first SBFD configuration, the UE 115 may determine the actual repetitions 315. In some examples, the UE 115 may drop nominal repetitions 310 that span or overlap with invalid symbol types. As an illustrative example, if a nominal repetition 310 fully spanned a set of non-SBFD symbols, the UE 115 may drop the nominal repetition 310.

In some examples, if a quantity of valid symbols associated with a nominal repetition 310 is greater than zero, then the UE 115 may segment the nominal repetition 310 into multiple actual repetitions 315. That is, if the quantity of potentially valid symbols for PUSCH repetition type B transmission is greater than zero for a nominal repetition 310 in SBFD symbols, the nominal repetition 310 may include one or more actual repetitions 315.

As an illustrative example, the nominal repetition 310-d spans SBFD symbols 11, 12, and 13 of slot 305-b and also spans non-SBFD symbols 0, 1, 2, and 3 of the slot 305-c. As such, because the nominal repetition 310-d spans 3 SBFD symbols (e.g., and 3>0), the UE 115 may segment the nominal repetition 310-d into the actual repetition 315-e (transmitted via symbols 11, 12, and 13 of slot 305-b) and into the invalid repetition 320, where the invalid repetition 320 is dropped.

Further, as described herein, the UE 115 may also segment the nominal repetitions 310 into multiple actual repetitions 315 according to slot boundaries. As an illustrative example, the nominal repetition 310-a may span symbols 11, 12, and 13 of the slot 305-a and span symbols 0, 1, 2, and 3 of the slot 305-b. Accordingly, the UE 115 may segment the nominal repetition into the actual repetition 315-b (e.g., transmitted via the symbols 11, 12, and 13 of the slot 305-a) and into the actual repetition 315-c (e.g., transmitted via the symbols 0, 1, 2, and 3 of the slot 305-b).

The UE 115 may transmit the actual repetitions 315 according to the respective symbols in response to determining the actual repetitions 315 from the nominal repetitions 310.

FIG. 4 shows an example of a resource diagram 400 that supports PUSCH repetitions in SBFD operations. Aspects of the resource diagram 400 may implement, or be implemented by, aspects of the wireless communications system 100, the signaling diagram 200, and the resource diagram 300. For example, the resource diagram 400 may be implemented by a UE 115, as described herein. Techniques described in the context of the resource diagram 400 may enable the UE 115 to identify the actual repetitions 415 from the nominal repetitions 410 while operating according to the first SBFD configuration.

For example, as described herein with reference to FIG. 2, the UE 115 may receive control signaling that indicates a pattern of downlink symbols, flexible symbols, and uplink symbols across one or more slots 405, where the control signaling further indicates that a subset of the downlink symbols, a subset of the uplink symbols, or both correspond to SFBD symbols. As illustrated in the resource diagram 400, the control signaling may indicate that symbols 0-13 of slot 405-a correspond to uplink symbols (e.g., non-SBFD symbols), while symbols 0-13 of slot 405-b correspond to SBFD symbols.

In some examples, the UE 115 may be configured to operate according to the first SBFD configuration for the SBFD symbols in the slot 405-b. Additionally, the UE 115 may receive a message that indicates the nominal repetitions 410-a and 410-b (e.g., the message indicates K=2, L=7, and S=3).

In response to receiving the message, the UE 115 may determine the actual repetitions 415, such as the actual repetitions 415-a and 415-b, from the nominal repetitions 410 according to valid symbols and invalid symbols, according to slot boundaries, or both.

As described herein with reference to FIG. 2, in some examples, the UE 115 may determine the valid symbols according to the symbol type of the first transmission occasion of the first nominal repetition (e.g., the nominal repetition 410-a). In such examples, the UE 115 may determine that the valid symbol type corresponds to the non-SBFD symbols due to symbols 4-10 corresponding to the nominal repetition 410-a being non-SBFD symbols. As such, the UE 115 may determine that the invalid symbol type corresponds to the SBFD symbols.

In some other examples, the UE 115 may determine the valid symbols according to the symbol type of the first transmission occasion of the first actual repetition (e.g., the actual repetition 415-a). In such examples, the UE 115 may determine that the valid symbol type corresponds to the non-SBFD symbols due to symbols 4-10 corresponding to the actual repetition 415-a being non-SBFD symbols. As such, the UE 115 may determine that the invalid symbol type corresponds to the SBFD symbols.

In some other examples, if the PUSCH transmissions correspond to configured grant type 1 PUSCH transmissions, the UE 115 may determine the valid symbol type according to an indication from a network entity 105. In such examples, the UE 115 may receive an indication that the valid symbol type corresponds to a non-SBFD symbol.

In response to determining the non-SBFD symbols correspond to the valid symbol type and in accordance with operating in the first SBFD configuration, the UE 115 may determine the actual repetitions 415. In some examples, the UE 115 may drop nominal repetitions 410 that span or overlap with invalid symbol types. As an illustrative example, if a nominal repetition 410 fully spanned a set of SBFD symbols, the UE 115 may drop the nominal repetition 410.

In some examples, if a quantity of valid symbols associated with a nominal repetition 410 is greater than zero, then the UE 115 may segment the nominal repetition into multiple actual repetitions. That is, if the quantity of potentially valid symbols for PUSCH repetition type B transmission is greater than zero for a nominal repetition 410 in SBFD symbols, the nominal repetition 410 may include one or more actual repetitions 415.

As an illustrative example, the nominal repetition 410-b spans non-SBFD symbols 10, 11, 12, and 13 of slot 405-a and also spans SBFD symbols 0, 1, and 2 of the slot 405-b. As such, because the nominal repetition 410-b spans 4 non-SBFD symbols (e.g., and 4>0), the UE 115 may segment the nominal repetition 410-b into the actual repetition 415-b (transmitted via symbols 10, 11, 12, and 13 of slot 405-a) and into the invalid repetition 420, where the invalid repetition 420 is dropped.

Accordingly, the UE 115 may transmit the actual repetitions 415 according to the respective symbols in response to determining the actual repetitions 415 from the nominal repetitions 410.

FIG. 5 shows an example of a resource diagram 500 that supports PUSCH repetitions in SBFD operations. Aspects of the resource diagram 500 may implement, or be implemented by, aspects of the wireless communications system 100, the signaling diagram 200, the resource diagram 300, and the resource diagram 400. For example, the resource diagram 500 may be implemented by a UE 115, as described herein. Techniques described in the context of the resource diagram 500 may enable the UE 115 to perform frequency hopping for actual repetitions 515 while operating according to the first SBFD configuration.

As described herein with reference to FIG. 3, the UE 115 may determine the actual repetitions 515-a, 515-b, 515-c, 515-d, and 515-e and the invalid repetition 520 according to the valid symbol types (e.g., SBFD symbols in this illustration), the invalid symbols types (e.g., non-SBFD symbols in this illustration), and slot boundaries of the slots 505-a, 505-b, and 505-c.

Accordingly, if frequency hopping is enabled at the UE 115, the UE 115 may transmit actual repetitions 515 that correspond to even numbered nominal repetitions 510 via the RB 525-a and transmit actual repetitions 515 that correspond to odd numbered repetitions 510 via the RB 525-b. As an illustrative example, the nominal repetitions 510-a and 510-d may correspond to even numbers (e.g., nominal repetition 0 and 2), while the nominal repetitions 510-c and 510-d may correspond to odd numbers (e.g., nominal repetition number 1 and 3).

As such, because the actual repetitions 515-a and 515-d correspond the nominal repetitions 510-a and 510-c, the UE 115 may transmit the actual repetitions 515-a and 515-d via the RB 525-a. Similarly, because the actual repetitions 515-b, 515-c, and 515-e correspond to the nominal repetitions 510-b and 510-d, the UE 115 may transmit the actual repetitions 515-b, 515-c, and 515-e via the RB 525-b, where the RB 525-b may be offset from the RB 525-a.

In such examples, for PUSCH Type B repetition with inter-repetition frequency hopping in SBFD symbols, and for an actual repetition 515 within the n-th nominal repetition 510 in SBFD symbols, the starting RB (e.g., RBₛₜₐᵣₜ(n)) may be given by Equation 2. That is, to determine the starting RB (e.g., RBₛₜₐᵣₜ(n)) for each of the actual repetitions 515, the UE 115 may utilize Equation 2:

$$R {B}_{start} ( n ) = \{ \begin{matrix}{RB}_{start} , n mod 2 = 0 \\ {RB}_{ULSB start} + ( {RB}_{start} - {RB}_{ULSB start} + {RB}_{offset} ) mod {N}_{ULSB}^{size} , n mod 2 = 1\end{matrix} \qquad ( 2 )$$

RBₛₜₐᵣₜ may correspond to a starting RB index (e.g., given by the resource indication value of the frequency domain resource assignment) of the actual repetitions 515 within the uplink subband associated with the SBFD symbols, RB_{UL SB start} may correspond to the starting RB index of the uplink subband associated with the SBFD symbols, RB_{offset} may be a RB offset (e.g., received via the control signaling 205 or message 210),

$${N}_{U L S B}^{s i z e}$$

may a size of the uplink subband of the SBFD symbols, and n corresponds to the index of the nominal repetition 510. In this way, by using equation 2, the UE 115 may perform frequency hopping for the actual repetitions 515 within an uplink subband of the SBFD symbols.

Accordingly, the UE 115 may transmit the actual repetitions 515 according to the respective symbols and RBs 525 in response to determining the actual repetitions 515 from the nominal repetitions 510.

FIG. 6 shows an example of a resource diagram 600 that supports PUSCH repetitions in SBFD operations. Aspects of the resource diagram 600 may implement, or be implemented by, aspects of the wireless communications system 100, the signaling diagram 200, the resource diagram 300, the resource diagram 400, and the resource diagram 500, as described herein. For example, the resource diagram 600 may be implemented by a UE 115, as described herein. The techniques described in the context of the resource diagram 600 may enable the UE 115 to identify actual repetitions 615 from nominal repetitions 610 while operating according to the second SBFD configuration.

In some cases, for a configured grant PUSCH configuration without repetitions, if the transmission occasions are across SBFD symbols and non-SBFD symbols, where each transmission occasion has either all SBFD or all non-SBFD symbols (e.g., the second SBFD configuration), for PUSCH repetition type A across SBFD symbols and non-SBFD symbols in different slots where each repetition has either all SBFD or all non-SBFD symbols (e.g., the second SBFD configuration), and for multi-PUSCH scheduled by a single DCI across SBFD symbols and non-SBFD symbols, where each PUSCH within a slot 305 has either all SBFD or all non-SBFD symbols (e.g., the second SBFD configuration), and for TBoMS across SBFD symbols and non-SBFD symbols in different slots, where each transmission within a slot has either all SBFD or all non-SBFD symbols e.g., the second SBFD configuration), the UE 115 may utilize a single resource configuration and/or indication for non-SBFD symbols and RB offset(s) configuration (e.g., indication or determination) to determine frequency resource for SBFD symbols. In such cases, the quantity of PRBs is the same for PUSCH transmissions in SBFD symbols and PUSCH transmissions in non-SBFD symbols.

For example, at least in case when PUSCH frequency hopping is not enabled, for a configured grant PUSCH configuration without repetitions, if the transmission occasions are across SBFD symbols and non-SBFD symbols, where each transmission occasion has either all SBFD or all non-SBFD symbols (e.g., the second SBFD configuration), for PUSCH repetition type A across SBFD symbols and non-SBFD symbols in different slots where each repetition has either all SBFD or all non-SBFD symbols (e.g., the second SBFD configuration), and for multi-PUSCH scheduled by a single DCI across SBFD symbols and non-SBFD symbols, where each PUSCH within a slot has either all SBFD or all non-SBFD symbols (e.g., the second SBFD configuration), and for TBoMS across SBFD symbols and non-SBFD symbols in different slots, where each transmission within a slot has either all SBFD or all non-SBFD symbols (i.e., Configuration 2), the UE 115 may utilize Equation 3 for determining starting PRB for PUSCH transmissions in SBFD symbols.

That is, for various operations according to the second SBFD configuration, the UE 115 may utilize Equation 3 to identify the starting RB for PUSCH transmissions in SBFD symbols:

$$R {B}_{start}^{S B F D} = R {B}_{start}^{U L S B} + ( R {B}_{start}^{non - SBFD} + R {B}_{offset}^{S B F D} ) mod {N}_{U L S B}^{s i z e} \qquad ( 3 )$$

$$R {B}_{start}^{S B F D}$$

may correspond to the starting RB for PUSCH transmissions in SBFD symbols,

$$R {B}_{start}^{U L S B}$$

may correspond to the starting RB index of the uplink subband associated with the SBFD symbols,

$$R {B}_{start}^{non - SBFD}$$

may correspond to starting RB index of the uplink BWP associated with the non-SBFD symbols (e.g., the uplink or flexible symbols),

$$R {B}_{offset}^{S B F D}$$

may correspond to an RB offset associated with the SBFD symbols (e.g., provided by the control signaling 205 or the message 210), and

$${N}_{U L S B}^{s i z e}$$

may correspond to a size of the uplink subband associated with the SBFD symbols. In such examples, if

$$R {B}_{offset}^{S B F D}$$

is not configured, the UE 115 may assume that the

$$R {B}_{offset}^{S B F D}$$

is set to zero.

As described herein, the UE 115 may also use Equation 3 to determine the starting RBs 625 for the actual repetitions 615 (e.g., PUSCH type B repetitions) while operating according to the second SBFD configuration and while frequency hopping is disabled. For example, the UE 115 may receive control signaling that indicates a pattern of downlink symbols, flexible symbols, and uplink symbols across one or more slots, where the control signaling further indicates that a subset of the downlink symbols, a subset of the uplink symbols, or both correspond to SFBD symbols. As illustrated in the resource diagram 600, the control signaling may indicate that symbols 0-13 of slot 605-a correspond to non-SBFD symbols (e.g., uplink symbols), while symbols 0-13 of slots 605-b and 605-c correspond to SBFD symbols.

The UE 115 may receive a message that indicates the nominal repetitions 610-a, 610-b, 610-c, and 610-d (e.g., the message indicates K=4, L=7, and S=3). In response to receiving the message, the UE 115 may determine the actual repetitions 615, such as the actual repetitions 615-a, 615-b, 615-c, 615-d, 615-e, and 615-f, from the nominal repetitions 610 according to valid symbols, according to slot boundaries, or both.

In such examples, while the UE 115 is configured to operate according to the second SBFD configuration, the UE 115 may consider the SBFD symbols configured in downlink symbols (or flexible symbols) via the control signaling (e.g., tdd-UL-DL-ConfigurationCommon or tdd-UL-DL-ConfigurationDedicated) as valid symbols and may also consider the non-SBFD symbols, such as uplink symbols and flexible symbols as also valid symbols. As such, the UE 115 may determine to segment one or more nominal repetitions 610 around slot boundaries, around downlink symbols, or both.

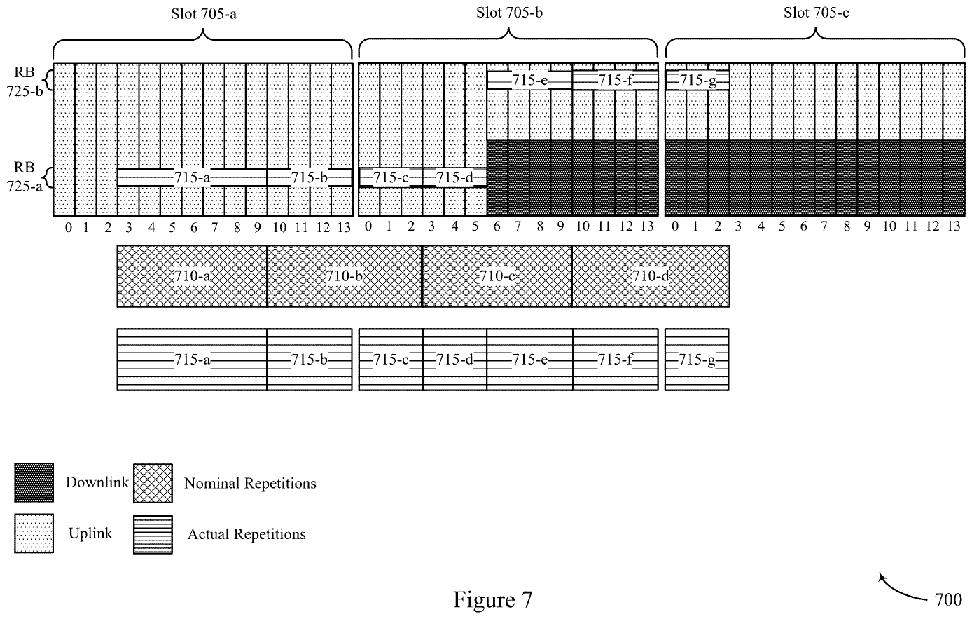

For example, the UE 115 may determine to segment the nominal repetition 610-b into the actual repetitions 615-b and 615-c due to the nominal repetition 610-b spanning symbols from the slot 605-a and the slot 605-b. Similarly, the UE 115 may determine to segment the nominal repetition 610-d into the actual repetitions 615-e and 615-f due to the nominal repetition 610-d spanning symbols from the slot 605-b and the slot 605-c. Techniques to segment nominal repetitions 610 while operating according to the second SBFD configuration may be further described herein with reference to FIGS. 7-9.

Regarding the application of the frequency offset to determine the starting RB 625-b in the SBFD symbols, the starting RB 625-b for the SBFD symbols may be determined for the actual repetitions 615 in the SBFD symbols using Equation 3, where

$$R {B}_{offset}^{S B F D}$$

may be configured per UL BWP in PUSCH-Config. The UE 115 may identify the starting index of the RB 625-a

$$( e . g . , {RB}_{start}^{non - SBFD} ) .$$

Subsequently, the UE 115 may utilize Equation 3 to identify the starting index of the RB 625-b

$$( e . g . , {RB}_{start}^{SBFD} ) .$$

Accordingly, the UE 115 may transmit the actual repetitions 615 according to the respective symbols and RBs 625 in response to determining the actual repetitions 615 from the nominal repetitions 610.

FIG. 7 shows an example of a resource diagram 700 that supports PUSCH repetitions in SBFD operations. Aspects of the resource diagram 700 may implement, or be implemented by, aspects of the wireless communications system 100, the signaling diagram 200, the resource diagram 300, the resource diagram 400, the resource diagram 500, and the resource diagram 600, as described herein. For example, the resource diagram 700 may be implemented by a UE 115, as described herein. The techniques described in the context of the resource diagram 700 may enable the UE 115 to identify actual repetitions 715 from nominal repetitions 710 while operating according to the second SBFD configuration.

For example, as described herein with reference to FIG. 2, the UE 115 may receive control signaling that indicates a pattern of downlink symbols, flexible symbols, and uplink symbols across one or more slots 705, where the control signaling further indicates that a subset of the downlink symbols, a subset of the uplink symbols, or both correspond to SFBD symbols. As illustrated in the resource diagram 700, the control signaling may indicate that symbols 0-13 of slot 705-a and symbols 0-5 of slot 705-b correspond to uplink symbols (e.g., non-SBFD symbols), while symbols 6-13 of slot 705-b and symbols 0-13 of slot 705-c correspond to SBFD symbols.

In some examples, the UE 115 may be configured to operate according to the second SBFD configuration for the SBFD symbols in the slot 705-b and 705-c. Additionally, the UE 115 may receive a message that indicates the nominal repetitions 710-a, 710-b, 710-c, and 710-d (e.g., the message indicates K=4, L=7, and S=3).

In response to receiving the message, the UE 115 may determine the actual repetitions 715, such as the actual repetitions 715-a, 715-b, 715-c, 715-d, 715-e, 715-f, and 715-g, from the nominal repetitions 710 according to the valid symbol type (e.g., both SBFD and non-SBFD symbols), according to slot boundaries, and according boundaries from SBFD symbols to non-SBFD symbols within a slot 705.

As an illustrative example, the UE 115 may segment the nominal repetition 710-b into actual repetitions 715-b and 715-c due to the nominal repetition 710-b spanning symbols of the slot 705-a and the slot 705-b. Similarly, the UE 115 may segment the nominal repetition 710-d into actual repetitions 715-f and 715-g due to the nominal repetition 710-d spanning symbols of the slot 705-b and the slot 705-c.

Further, in some examples, the UE 115 may segment the nominal repetition 710-c into the actual repetitions 715-d and 715-e (e.g., two actual repetitions) across SBFD and non-SBFD symbols boundaries within a slot. For example, because the nominal repetition 710-c spans the non-SBFD symbols 3, 4, and 5 of slot 705-b and spans the SBFD symbols 6, 7, 8, and 9 of the slot 705-b, the UE 115 may determine to segment the nominal repetition 710-c into the actual repetition 715-d (e.g., transmitted via the symbols 3, 4, and 5 of slot 705-b) and into the actual repetition 715-e (e.g., transmitted via the symbols 6, 7, 8, and 9 of the slot 705-b). In this way, an actual repetition 715 may be formed of contiguous symbols of the same symbol type in a slot 705. In such examples, the UE 115 may determine the RB 725-a according to the

$${RB}_{start}^{non - SBFD}$$

and determine the RB 725-b according to Equation 3, as described herein start with reference to FIG. 6.

Accordingly, the UE 115 may transmit the actual repetitions 715 according to the respective symbols and RBs 725 in response to determining the actual repetitions 715 from the nominal repetitions 710.

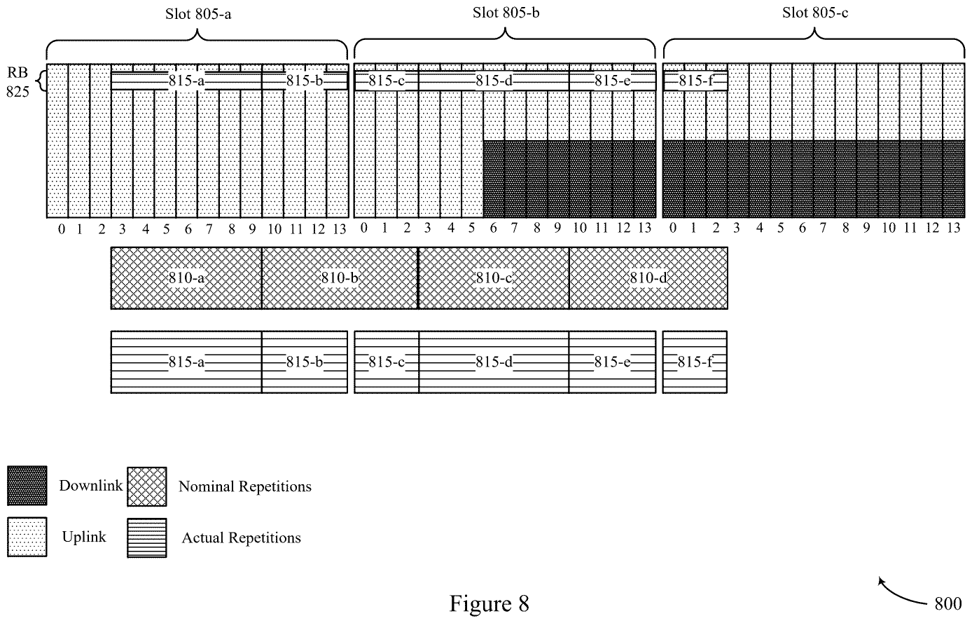

FIG. 8 shows an example of a resource diagram 800 that supports PUSCH repetitions in SBFD operations. Aspects of the resource diagram 800 may implement, or be implemented by, aspects of the wireless communications system 100, the signaling diagram 200, the resource diagram 300, the resource diagram 400, the resource diagram 500, the resource diagram 600, and the resource diagram 700, as described herein. For example, the resource diagram 800 may be implemented by a UE 115, as described herein. The techniques described in the context of the resource diagram 800 may enable the UE 115 to identify actual repetitions 815 from nominal repetitions 810 while operating according to the second SBFD configuration.

For example, as described herein with reference to FIG. 2, the UE 115 may receive control signaling that indicates a pattern of downlink symbols, flexible symbols, and uplink symbols across one or more slots 805, where the control signaling further indicates that a subset of the downlink symbols, a subset of the uplink symbols, or both correspond to SFBD symbols. As illustrated in the resource diagram 800, the control signaling may indicate that symbols 0-13 of slot 805-a and symbols 0-5 of slot 805-b correspond to uplink symbols (e.g., non-SBFD symbols), while symbols 6-13 of slot 805-b and symbols 0-13 of slot 805-c correspond to SBFD symbols.

In some examples, the UE 115 may be configured to operate according to the second SBFD configuration for the SBFD symbols in the slot 805-b and 805-c. Additionally, the UE 115 may receive a message that indicates the nominal repetitions 810-a, 810-b, 810-c, and 810-d (e.g., the message indicates K=4, L=7, and S=3).

In response to receiving the message, the UE 115 may determine the actual repetitions 815, such as the actual repetitions 815-a, 815-b, 815-c, 815-d, 815-e, and 815-f, from the nominal repetitions 810 according to the valid symbol type (e.g., both SBFD and non-SBFD symbols), according to slot boundaries, and according to boundary between SBFD and non-SBFD symbols within a slot 805.

As an illustrative example, the UE 115 may segment the nominal repetition 810-b into actual repetitions 815-b and 815-c due to the nominal repetition 810-b spanning symbols of the slot 805-a and the slot 805-b. Similarly, the UE 115 may segment the nominal repetition 810-d into actual repetitions 815-e and 815-f due to the nominal repetition 810-d spanning symbols of the slot 805-b and the slot 805-c.

In some examples, the UE 115 may refrain from segmenting a nominal repetition 810, such as the nominal repetition 810-c, that spans non-SBFD symbols and SBFD symbol boundaries into multiple actual repetitions 815. For example, if the starting RB index of the non-SBFD symbols

$$( e . g . , {RB}_{start}^{non - SBFD} )$$

and the starting RB index for the SBFD symbols

$$( e . g . , {RB}_{start}^{SBFD} )$$

are the same and the starting RB index of the non-SBFD symbols is in the uplink subband the SBFD symbols, then the UE 115 may refrain from segmenting the nominal repetition 810-c into multiple actual repetitions 815. Otherwise, the nominal repetition 810 may be segmented according to the techniques described herein with reference to FIG. 7. In this way, an actual repetition 815 may be formed of contiguous symbols with different SBFD and non-SBFD types (e.g., different valid symbol types). The actual repetition 815 may be formed of contiguous symbols with different SBFD and non-SBFD types with same start RB and quantity of RBs in both symbol types. In such examples, the UE 115 may determine the

$$R {B}_{start}^{S B F D}$$

according to Equation 3, as described herein with reference to determine the FIG. 6.

Accordingly, the UE 115 may transmit the actual repetitions 815 according to the respective symbols and the RB 825 in response to determining the actual repetitions 815 from the nominal repetitions 810.

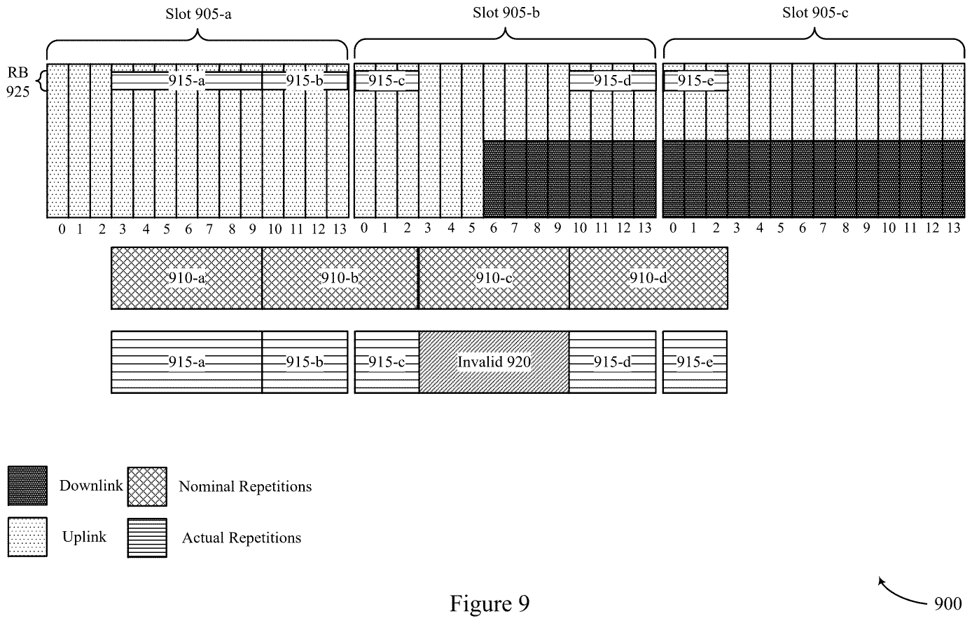

FIG. 9 shows an example of a resource diagram 900 that supports PUSCH repetitions in SBFD operations. Aspects of the resource diagram 900 may implement, or be implemented by, aspects of the wireless communications system 100, the signaling diagram 200, the resource diagram 300, the resource diagram 400, the resource diagram 500, the resource diagram 600, the resource diagram 700, and the resource diagram 800, as described herein. For example, the resource diagram 900 may be implemented by a UE 115, as described herein. The techniques described in the context of the resource diagram 900 may enable the UE 115 to identify actual repetitions 915 from nominal repetitions 910 while operating according to the second SBFD configuration.

For example, as described herein with reference to FIG. 2, the UE 115 may receive control signaling that indicates a pattern of downlink symbols, flexible symbols, and uplink symbols across one or more slots 905, where the control signaling further indicates that a subset of the downlink symbols, a subset of the uplink symbols, or both correspond to SFBD symbols. As illustrated in the resource diagram 900, the control signaling may indicate that symbols 0-13 of slot 905-a and symbols 0-5 of slot 905-b correspond to uplink symbols (e.g., non-SBFD symbols), while symbols 6-13 of slot 905-b and symbols 0-13 of slot 905-c correspond to SBFD symbols.

In some examples, the UE 115 may be configured to operate according to the second SBFD configuration for the SBFD symbols in the slot 905-b and 905-c. Additionally, the UE 115 may receive a message that indicates the nominal repetitions 910-a, 910-b, 910-c, and 910-d (e.g., the message indicates K=4, L=7, and S=3).

In response to receiving the message, the UE 115 may determine the actual repetitions 915, such as the actual repetitions 915-a, 915-b, 915-c, 915-d, and 915-e, from the nominal repetitions 910 according to the valid symbol type (e.g., both SBFD and non-SBFD symbols), according to slot boundaries, and boundaries between SBFD and non-SBFD symbols within a slot.

As an illustrative example, the UE 115 may segment the nominal repetition 910-b into actual repetitions 915-b and 915-c due to the nominal repetition 910-b spanning symbols of the slot 905-a and the slot 905-b. Similarly, the UE 115 may segment the nominal repetition 910-d into actual repetitions 915-d and 915-e due to the nominal repetition 910-d spanning symbols of the slot 905-b and the slot 905-c.

In some examples, the UE 115 may drop nominal repetitions 910 that span non-SBFD and SBFD symbol boundaries. For example, the UE 115 may determine that the nominal repetition 910-c is an invalid repetition 920 due to the nominal repetition 910-c spanning both SBFD symbols and non-SBFD symbols of the slot 905-b and may drop the nominal repetition 910-c. Accordingly, the UE 115 may transmit the actual repetitions 915 according to the respective symbols and the RB 925 in response to determining the actual repetitions 915 from the nominal repetitions 910.

FIG. 10 shows an example of a resource diagram 1000 that supports PUSCH repetitions in SBFD operations. Aspects of the resource diagram 1000 may implement, or be implemented by, aspects of the wireless communications system 100, the signaling diagram 200, the resource diagram 300, the resource diagram 400, the resource diagram 500, the resource diagram 600, the resource diagram 700, the resource diagram 800, and the resource diagram 900, as described herein. For example, the resource diagram 1000 may be implemented by a UE 115, as described herein. The techniques described in the context of the resource diagram 1000 may enable the UE 115 to perform frequency hopping for the actual repetitions 1015 while operating according to the second SBFD configuration.

For example, as described herein with reference to FIG. 2, the UE 115 may receive control signaling that indicates a pattern of downlink symbols, flexible symbols, and uplink symbols across one or more slots 1005, where the control signaling further indicates that a subset of the downlink symbols, a subset of the uplink symbols, or both correspond to SFBD symbols. As illustrated in the resource diagram 1000, the control signaling may indicate that symbols 0-13 of slot 1005-a correspond to uplink symbols (e.g., non-SBFD symbols), while symbols 0-13 of slot 1005-b and symbols 0-4 of slot 1005-c correspond to SBFD symbols.

In some examples, the UE 115 may be configured to operate according to the second SBFD configuration for the SBFD symbols in the slot 1005-b and 1005-c. Additionally, the UE 115 may receive a message that indicates the nominal repetitions 1010-a, 1010-b, 1010-c, and 1010-d (e.g., the message indicates K=4, L=7, and S=3).

In response to receiving the message, the UE 115 may determine the actual repetitions 1015, such as the actual repetitions 1015-a, 1015-b, 1015-c, 1015-d, 1015-e, and 1015-f, from the nominal repetitions 1010 according to the techniques described herein with reference to FIGS. 6-9. As an illustrative example, the UE 115 may segment the nominal repetition 1010-b into actual repetitions 1015-b and 1015-c due to the nominal repetition 1010-b spanning symbols of the slot 1005-a and the slot 1005-b. Similarly, the UE 115 may segment the nominal repetition 1010-d into actual repetitions 1015-e and 1015-f due to the nominal repetition 1010-d spanning symbols of the slot 1005-b and the slot 1005-c.

In some examples, if frequency hopping is enabled at the UE 115, the UE 115 may determine the starting RB indices for actual repetitions 1015 according to one or more equations. In frequency hopping, each actual repetition 1015 corresponding to an even numbered nominal repetition 1010 within the non-SBFD symbols may have a same first starting RB index, while each actual repetition 1015 corresponding to an odd numbered nominal repetition 1010 within the non-SBFD symbols may have a same second starting RB index. Similarly, each actual repetition 1015 corresponding to an even numbered nominal repetition 1010 within the SBFD symbols may have a same third starting RB index, while each actual repetition 1015 corresponding to an odd numbered nominal repetition 1010 within the SBFD symbols may have a same fourth starting RB index.

For example, the UE 115 may identify the starting index for the RB 1025-a and the starting index for the RB 1025-b according to Equation 1, as described herein with reference to FIG. 2. In response to identifying the starting index for the RB 1025-a and the RB 1025-b, the UE 115-a may identify the starting RB index for the actual repetitions 1015 corresponding to even numbered nominal repetitions 1010 within SBFD symbols

$$( e . g . , {RB}_{start}^{SBFD} )$$

according to Equation 3, as described herein with reference to FIG. 6, where

$$R {B}_{start}^{non - SBFD}$$

is equal is the starting index for the RB 1025-a (e.g., RBₛₜₐᵣₜ).

In response to identifying

$$R {B}_{start}^{S B F D} ,$$

the UE 115 may calculate the starting RB index for the RB 1025-c and the starting RB index for the RB 1025-d according to Equation 4:

$$R {B}_{start} ( n ) = \{ \begin{matrix}R {B}_{start}^{S B F D} , n mod 2 = 0 \\ {RB}_{ULSB start} + ( {RB}_{start}^{SBFD} - {RB}_{ULSB start} + {RB}_{offset} ) mod {N}_{ULSB}^{size} , n mod 2 = 1\end{matrix} \qquad ( 4 )$$

$$R {B}_{start}^{S B F D}$$

may correspond to the starting RB for PUSCH transmissions in SBFD symbols,

$$R {B}_{start}^{U L S B}$$

may correspond to the starting RB index of the uplink subband associated with the SBFD symbols, RB_{offset} may correspond to a RB offset (e.g., indicated via the control signaling 205 or the message 210), and

$${N}_{U L S B}^{s i z e}$$

may correspond to a size of the uplink subband associated with the SBFD symbols. In this way, the UE 115 may perform frequency hopping for actual repetitions 1015 across SBFD and non-SBFD symbols while operating according to the second SBFD configuration.

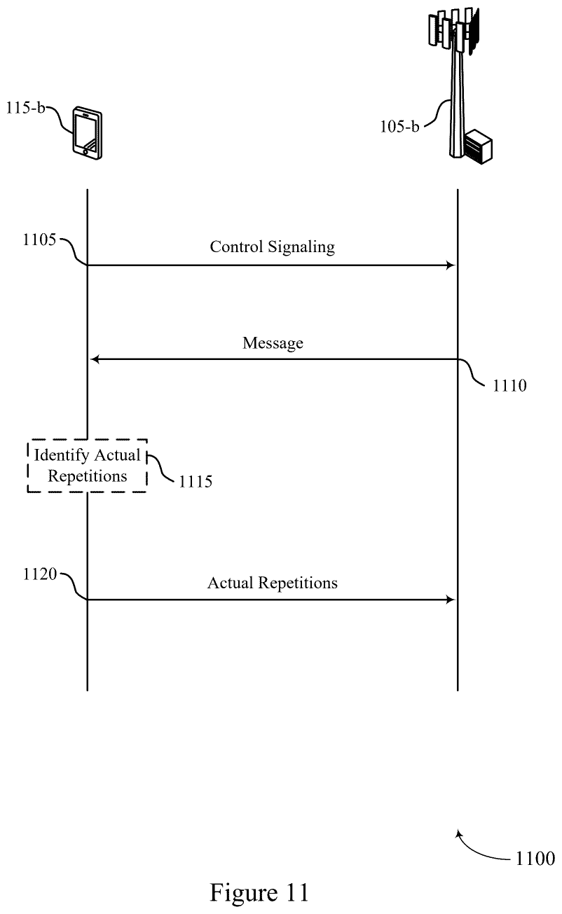

FIG. 11 shows an example of a process flow 1100 that supports PUSCH repetitions in SBFD operations. Aspects of the process flow 1100 may implement, or be implemented by, aspects of the wireless communications system 100, the signaling diagram 200, the resource diagram 300, the resource diagram 400, the resource diagram 500, the resource diagram 600, the resource diagram 700, the resource diagram 800, the resource diagram 900, and the resource diagram 1000, as described herein. For example, the process flow 1100 may be implemented by a UE 115-b and a network entity 105-b, which may be examples of corresponding devices as described herein. The techniques described in the context of the process flow 1100 may enable the UE 115-b to transmit actual repetitions of a PUSCH transmission (e.g., PUSCH repetition type B transmissions) in conjunction with SBFD operations.

At 1105, the UE 115-b may receive control signaling (e.g., control signaling 205) that indicates a pattern (e.g., TDD pattern 220) of downlink symbols, uplink symbols, and flexible symbols across one or more slots, where the control signaling further indicates that a subset of the downlink symbols and a subset of the flexible symbols correspond to subband full duplex symbols (e.g., SBFD pattern 230).

At 1110, the UE 115-b may receive a message that indicates a set of nominal repetitions (e.g., the nominal repetitions 310, 410, 510, 610, 710, 810, 910, and 1010). In such examples, one or more nominal repetitions of the set may span non-SFBD symbols and SBFD symbols.

At 1115, the UE 115-b may identify a set of actual repetitions (e.g., the actual repetitions 315, 415, 515, 615, 715, 815, 915, and 1015) from the set of nominal repetitions according to valid symbol types, invalid symbol types, slot boundaries, symbol boundaries, among other criteria, where the valid symbol types and the invalid symbols may be based on the SBFD configuration applied at the UE 115-b. Techniques to identify the set of actual repetitions may be further described herein with reference to FIGS. 2-10. At 1120, the UE 115-b may transmit the set of actual repetitions.

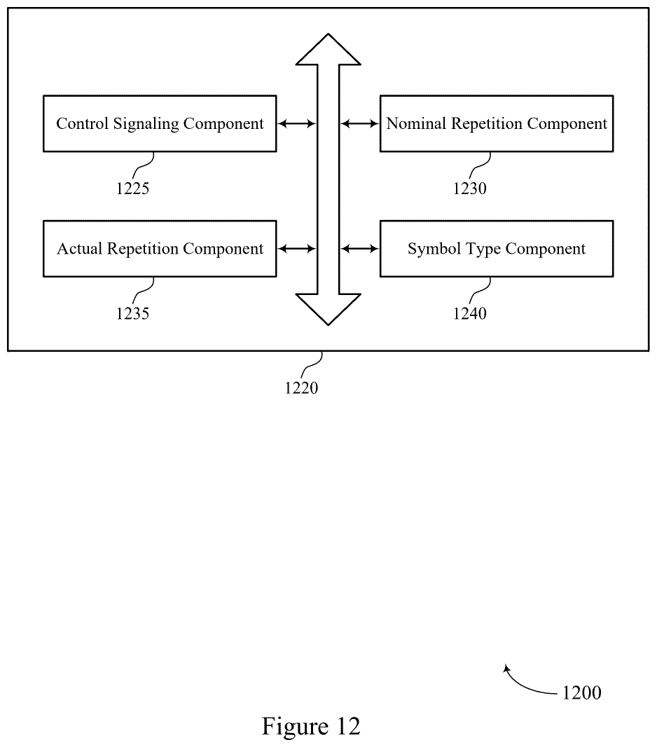

FIG. 12 shows an example of a processing system 1220 that supports PUSCH repetitions in SBFD operations. A processing system 1220 may be an example of a processing system 140 (such as of a UE 115) and may include a control signaling component 1225, a nominal repetition component 1230, an actual repetition component 1235, a symbol type component 1240, or any combination thereof. A processing system 1220, or various component thereof, may be an example of means for performing (such as a means for causing a UE 115 to perform) various techniques described herein.

The control signaling component 1225 may be configured to cause the UE 115 to receive control signaling that indicates a pattern of downlink symbols, uplink symbols, and flexible symbols across one or more slots, where the control signaling further indicates that a subset of the downlink symbols and a subset of the flexible symbols correspond to SBFD symbols. The nominal repetition component 1230 may be configured to cause the UE 115 to receive a message that indicates a set of nominal repetitions of a PUSCH, where one or more nominal repetitions of the set of nominal repetitions span at least a portion of the uplink symbols, a portion of the flexible symbols, or both, and span at least a portion of the SBFD symbols across the one or more slots. The actual repetition component 1235 may be configured to cause the UE 115 to transmit a set of actual repetitions of the PUSCH via the uplink symbols, the flexible symbols, the SBFD symbols, or a combination thereof, where the set of actual repetitions are identified from the set of nominal repetitions in accordance with valid symbol types.

In some examples, the valid symbol types correspond to a symbol type of a first transmission occasion of the set of nominal repetitions in accordance with a configuration associated with the SBFD symbols, the valid symbol types correspond to a symbol type of a first transmission occasion the set of actual repetitions in accordance with the configuration, or the valid symbol types are in accordance with an indication from a network entity.

In some examples, the valid symbol types include the SBFD symbols, and the symbol type component 1240 may be configured to cause the UE 115 to consider non-SBFD symbols as invalid symbol types for the set of nominal repetitions, where the non-SBFD symbols include the uplink symbols, a second subset of the downlink symbols, and a second subset of the flexible symbols. In some examples, the valid symbol types include the SBFD symbols, and the nominal repetition component 1230 may be configured to cause the UE 115 to drop a nominal repetition of the set of nominal repetitions in accordance with the nominal repetition spanning one or more non-SBFD symbols of the non-SBFD symbols, where the set of actual repetitions are in accordance with dropping the nominal repetition.

In some examples, the valid symbol types include the SBFD symbols, and the actual repetition component 1235 may be configured to cause the UE 115 to transmit at least a first actual repetition and a second actual repetition of the set of actual repetitions, where the first actual repetition and the second actual repetition correspond to a single nominal repetition of the set of nominal repetitions, where the single nominal repetition spans at least a single SBFD symbol.

In some examples, the valid symbol types include non-SBFD symbols, and the non-SBFD symbols include the uplink symbols and a second subset of the flexible symbols, and the symbol type component 1240 may be configured to cause the UE 115 to consider the SBFD symbols as invalid symbol types for the set of nominal repetitions. In some examples, the valid symbol types include non-SBFD symbols, and the nominal repetition component 1230 may be configured to cause the UE 115 to drop a nominal repetition of the set of nominal repetitions in accordance with the nominal repetition spanning one or more SBFD symbols of the SBFD symbols, where the set of actual repetitions are in accordance with dropping the nominal repetition.

In some examples, the valid symbol types include non-SBFD symbols, and the non-SBFD symbols include the uplink symbols and a second subset of the flexible symbols and the actual repetition component 1235 may be configured to cause the UE 115 to transmit at least a first actual repetition and a second actual repetition of the set of actual repetitions, where the first actual repetition and the second actual repetition correspond to a single nominal repetition of the set of nominal repetitions, where the single nominal repetition spans at least a single non-SBFD symbol.

In some examples, the valid symbol types include the SBFD symbols, and, to support transmitting the set of actual repetitions, the actual repetition component 1235 may be configured to cause the UE 115 to transmit a first actual repetition of the set of actual repetitions via a first RB of an uplink subband associated with the SBFD symbols, where the first actual repetition corresponds to an even numbered nominal repetition, and where the first RB is in accordance with a first RB index. In some examples, to support transmitting the set of actual repetitions, the actual repetition component 1235 may be configured to cause the UE 115 to transmit a second actual repetition of the set of actual repetitions via a second RB of the uplink subband, where the second actual repetition corresponds to an odd numbered nominal repetition, and where the second RB is offset from the first RB in accordance with the first RB index, a second RB index associated with a start of the uplink subband, a RB offset, and a size of the uplink subband.

In some examples, non-SBFD symbols and the SBFD symbols are valid symbols in accordance with a configuration associated with the SBFD symbols. In some examples, the non-SBFD symbols include the uplink symbols and a second subset of the flexible symbols.

In some examples, to support transmitting the set of actual repetitions, the actual repetition component 1235 may be configured to cause the UE 115 to transmit a first actual repetition via a first RB and one or more non-SBFD symbols of the non-SBFD symbols, where the first RB is in accordance with a first RB index. In some examples, to support transmitting the set of actual repetitions, the actual repetition component 1235 may be configured to cause the UE 115 to transmit a second actual repetition via a second RB and one or more SBFD symbols of the SBFD symbols, where the second RB is offset from the first RB in accordance with the first RB index, a second RB index associated with a start of an uplink subband associated with the SBFD symbols, a RB offset associated with the SBFD symbols, and a size of the uplink subband.

In some examples, a first portion of a first nominal repetition of the set of nominal repetitions spans one or more non-subband full duplex symbols of the non-subband full duplex symbols in a first slot and a second portion of the first nominal repetition spans one or more subband full duplex symbols of the subband full duplex symbols in the first slot, and to support transmitting the set of actual repetitions, the actual repetition component 1235 may be configured to cause the UE 115 to transmit a first actual repetition of the set of actual repetitions via a first RB and the one or more non-SBFD symbols of the first slot, where the first actual repetition corresponds to the first portion of the first nominal repetition. In some examples, to support transmitting the set of actual repetitions, the actual repetition component 1235 may be configured to cause the UE 115 to transmit a second actual repetition of the set of actual repetitions via a second RB and the one or more SBFD symbols of the first slot, where the second actual repetition corresponds to the second portion of the first nominal repetition.

In some examples, a first portion of a first nominal repetition of the set of nominal repetitions spans one or more non-subband full duplex symbols of the non-subband full duplex symbols in a first slot and a second portion of the first nominal repetition spans one or more subband full duplex symbols of the subband full duplex symbols in the first slot, and to support transmitting the set of actual repetitions, the actual repetition component 1235 may be configured to cause the UE 115 to transmit a first actual repetition of the set of actual repetitions via a first RB and via the one or more non-SBFD symbols and the one or more SBFD symbols in accordance with the first RB having a same starting RB index for both the non-SBFD symbols and the SBFD symbols and in accordance with the first RB being within an uplink subband associated with the SBFD symbols, where the first actual repetition corresponds to the first nominal repetition.

In some examples, a first portion of a first nominal repetition of the set of nominal repetitions spans one or more non-subband full duplex symbols of the non-subband full duplex symbols in a first slot and a second portion of the first nominal repetition spans one or more subband full duplex symbols of the subband full duplex symbols in the first slot, and the nominal repetition component 1230 may be configured to cause the UE 115 to drop the first nominal repetition in accordance with the first portion and the second portion of the first nominal repetition spanning both the one or more non-SBFD symbols and the one or more SBFD symbols in the first slot.

In some examples, to support transmitting the set of actual repetitions, the actual repetition component 1235 may be configured to cause the UE 115 to transmit a first actual repetition via a first RB and one or more first non-SBFD symbols of the non-SBFD symbols, where the first RB is in accordance with a first RB index. In some examples, to support transmitting the set of actual repetitions, the actual repetition component 1235 may be configured to cause the UE 115 to transmit a second actual repetition via a second RB and one or more second non-SBFD symbols of the non-SBFD symbols, where the second RB is offset from the first RB in accordance with the first RB index, a first RB offset associated with the uplink symbols, and a size of an uplink bandwidth associated with the non-SBFD symbols. In some examples, to support transmitting the set of actual repetitions, the actual repetition component 1235 may be configured to cause the UE 115 to transmit a third actual repetition via a third RB and one or more first SBFD symbols of the SBFD symbols, where the third RB is offset from a second RB index in accordance with the second RB index, a third RB index associated with a start of an uplink subband associated with the SBFD symbols, the first RB offset, and a size of the uplink subband. In some examples, to support transmitting the set of actual repetitions, the actual repetition component 1235 may be configured to cause the UE 115 to transmit a fourth actual repetition via a fourth RB and one or more second SBFD symbols of the SBFD symbols, where the fourth RB is in accordance with the second RB index.

In some examples, the second RB index is in accordance with the third RB index, the first RB index, a second RB offset associated with the SBFD symbols, and the size of the uplink subband.

In some examples, a first configuration and a second configuration associated with the SBFD symbols are not applicable for transmission of the set of actual repetitions. In some examples, the uplink symbols and the subset of the downlink symbols allocated as the SBFD symbols correspond to the valid symbol types.

In some examples, the subset of the downlink symbols indicated as the SBFD symbols are valid symbols.

A processing system 1220 may include or be a component of one or more chips, systems-on-chips (SoCs), chipsets, packages, components, or devices that individually or collectively constitute or include a processing system. A processing system 1220 may interface with other components of a processing system 1220. For example, operations described with reference to a processing system 1220, or various components thereof, may be performed by or with other such components, including a receiver, a transmitter, a transceiver, a modem, a user interface, a modulator/demodulator, an encoder/decoder, or any combination thereof (such as of the processing system 1220, coupled with the processing system 1220, of a processing system 1220).

By including or configuring a processing system 1220 for operation in a processing system 1220 as described herein, the processing system 1220 may support techniques for PUSCH repetitions in SBFD operations.

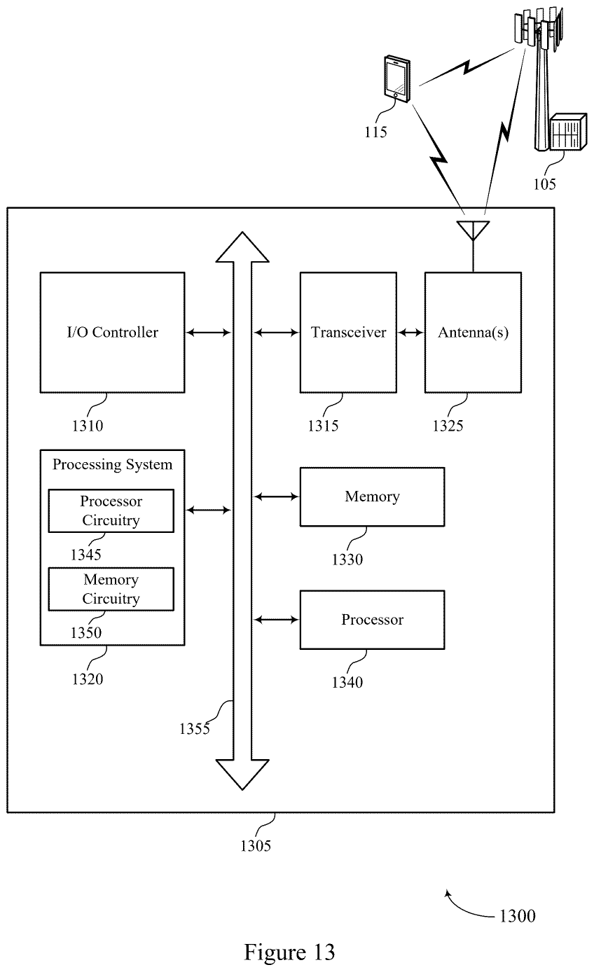

FIG. 13 shows an example of a system 1300 including a device 1305 that supports PUSCH repetitions in SBFD operations. The device 1305 may be an example of or include components of UE 115. The device 1305 may communicate (such as wirelessly) with one or more other devices (such as network entities 105, UEs 115). The device 1305 may include components for transmitting and receiving communication, which may include a processing system 1320, an input/output (I/O) controller, such as an I/O controller 1310, a transceiver 1315, antenna(s) 1325, a memory 1330, and a processor 1340. Components of the device 1305 may be coupled (such as operatively, communicatively, functionally, electronically, electrically, in electronic communication) a bus 1355.

The transceiver 1315 may support bi-directional communication via antenna(s) 1325, and may support transmission operations, reception operations, or both, as described herein. The transceiver 1315 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 1305). The transceiver 1315 may modulate symbols and provide the modulated symbols to antenna(s) 1325 for transmission, and demodulate symbols from signals received using antenna(s) 1325.

The processor 1340 may be a general-purpose processing component that supports various operations (such as applications) of the device 1305. The memory 1330 may be a general-purpose storage component that stores code executable by the processor 1340. Such code may include instructions that, when executed by the processor 1340, cause the device 1305 to perform various functions (such as to support an application of the device 1305). The I/O controller 1310 may manage inputs and outputs for the device 1305, may manage peripherals not integrated into the device 1305, or may represent a physical connection (such as port) to an external peripheral. The processor 1340 may interact with a modem, a keyboard, a mouse, a touchscreen, or other device (such as via I/O controller 1310). In some implementations, a user may interact with the device 1305 via the I/O controller 1310 or via hardware components controlled by the I/O controller 1310.

The processing system 1320 may be an example of a processing system 140 or a processing system 1200. For example, the processing system 1320 may include processor circuitry 1345 and memory circuitry 1350 that stores code, and may be configured to cause the device 1305 to perform operations that support PUSCH repetitions in SBFD operations. Although the processing system 1320 is illustrated as a separate component, which may involve a separate chip, chipset, or other module, in some implementations, one or more functions described with reference to the processing system 1320 may be supported by or performed by a transceiver 1315, antenna(s) 1325, a processor 1340, memory 1330, or any combination thereof, such that a processing system 1320 may include one or more of a transceiver 1315, antenna(s) 1325, a processor 1340, memory 1330, or any combination thereof.

By including or configuring the processing system 1320 for operation in the device 1305 as described herein, may support techniques for PUSCH repetitions in SBFD operations, thereby improving coordination between devices.

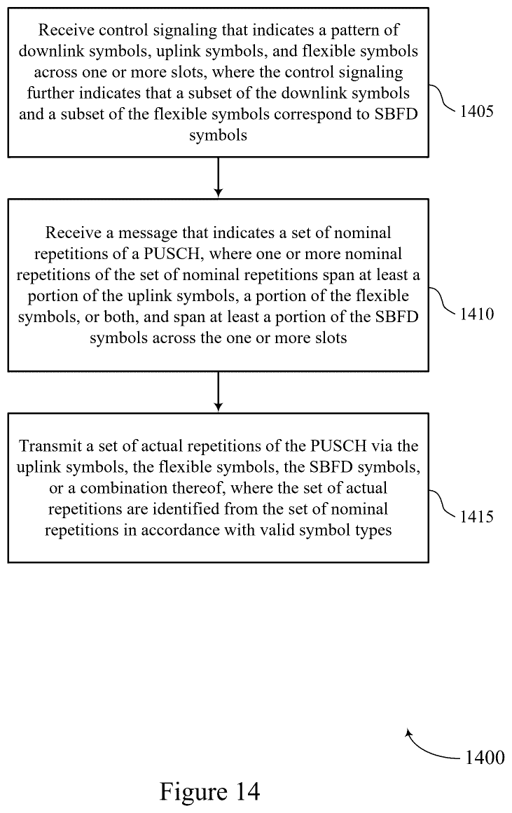

FIG. 14 shows an example of a method 1400 that supports PUSCH repetitions in SBFD operations. Operations of the method 1400 may be performed by a UE or its components (such as using a processing system configured to cause the UE 115 to perform one or more of the operations) as described herein.

At 1405, the method may include receiving control signaling that indicates a pattern of downlink symbols, uplink symbols, and flexible symbols across one or more slots, where the control signaling further indicates that a subset of the downlink symbols and a subset of the flexible symbols correspond to SBFD symbols. In some examples, aspects of the operations of 1405 may be performed by a control signaling component 1225.

At 1410, the method may include receiving a message that indicates a set of nominal repetitions of a PUSCH, where one or more nominal repetitions of the set of nominal repetitions span at least a portion of the uplink symbols, a portion of the flexible symbols, or both, and span at least a portion of the SBFD symbols across the one or more slots. In some examples, aspects of the operations of 1410 may be performed by a nominal repetition component 1230.

At 1415, the method may include transmitting a set of actual repetitions of the PUSCH via the uplink symbols, the flexible symbols, the SBFD symbols, or a combination thereof, where the set of actual repetitions are identified from the set of nominal repetitions in accordance with valid symbol types. In some examples, aspects of the operations of 1415 may be performed by an actual repetition component 1235.

Aspect 1: A method for wireless communications at a UE, comprising: receiving control signaling that indicates a pattern of downlink symbols, uplink symbols, and flexible symbols across one or more slots, wherein the control signaling further indicates that a subset of the downlink symbols and a subset of the flexible symbols correspond to SBFD symbols; receiving a message that indicates a set of nominal repetitions of a PUSCH, wherein one or more nominal repetitions of the set of nominal repetitions span at least a portion of the uplink symbols, a portion of the flexible symbols, or both, and span at least a portion of the SBFD symbols across the one or more slots; and transmitting a set of actual repetitions of the PUSCH via the uplink symbols, the flexible symbols, the SBFD symbols, or a combination thereof, wherein the set of actual repetitions are identified from the set of nominal repetitions in accordance with valid symbol types.

Aspect 2: The method of aspect 1, wherein the valid symbol types correspond to a symbol type of a first transmission occasion of the set of nominal repetitions in accordance with a configuration associated with the SBFD symbols, the valid symbol types correspond to a symbol type of a first transmission occasion the set of actual repetitions in accordance with the configuration, or the valid symbol types are in accordance with an indication from a network entity.

Aspect 3: The method of aspect 2, wherein the valid symbol types comprise the SBFD symbols, the method further comprising: considering non-SBFD symbols as invalid symbol types for the set of nominal repetitions, wherein the non-SBFD symbols comprise the uplink symbols, a second subset of the downlink symbols, and a second subset of the flexible symbols; and dropping a nominal repetition of the set of nominal repetitions in accordance with the nominal repetition spanning one or more non-SBFD symbols of the non-SBFD symbols, wherein the set of actual repetitions are in accordance with dropping the nominal repetition.

Aspect 4: The method of any of aspects 2 through 3, wherein the valid symbol types comprise the SBFD symbols, the method further comprising: transmitting at least a first actual repetition and a second actual repetition of the set of actual repetitions, wherein the first actual repetition and the second actual repetition correspond to a single nominal repetition of the set of nominal repetitions, wherein the single nominal repetition spans at least a single SBFD symbol.

Aspect 5: The method of any of aspects 2 through 4, wherein the valid symbol types comprise non-SBFD symbols, and wherein the non-SBFD symbols comprise the uplink symbols and a second subset of the flexible symbols, the method further comprising: considering the SBFD symbols as invalid symbol types for the set of nominal repetitions; and dropping a nominal repetition of the set of nominal repetitions in accordance with the nominal repetition spanning one or more SBFD symbols of the SBFD symbols, wherein the set of actual repetitions are in accordance with dropping the nominal repetition.

Aspect 6: The method of any of aspects 2 through 5, wherein the valid symbol types comprise non-SBFD symbols, and wherein the non-SBFD symbols comprise the uplink symbols and a second subset of the flexible symbols, the method further comprising: transmitting at least a first actual repetition and a second actual repetition of the set of actual repetitions, wherein the first actual repetition and the second actual repetition correspond to a single nominal repetition of the set of nominal repetitions, wherein the single nominal repetition spans at least a single non-SBFD symbol.

Aspect 7: The method of any of aspects 2 through 6, wherein the valid symbol types comprise the SBFD symbols, wherein transmitting the set of actual repetitions comprises: transmitting a first actual repetition of the set of actual repetitions via a first RB of an uplink subband associated with the SBFD symbols, wherein the first actual repetition corresponds to an even numbered nominal repetition, and wherein the first RB is in accordance with a first RB index; and transmitting a second actual repetition of the set of actual repetitions via a second RB of the uplink subband, wherein the second actual repetition corresponds to an odd numbered nominal repetition, and wherein the second RB is offset from the first RB in accordance with the first RB index, a second RB index associated with a start of the uplink subband, a RB offset, and a size of the uplink subband.

Aspect 8: The method of any of aspects 1 through 7, wherein non-SBFD symbols and the SBFD symbols are valid symbols in accordance with a configuration associated with the SBFD symbols, and the non-SBFD symbols comprise the uplink symbols and a second subset of the flexible symbols.

Aspect 9: The method of aspect 8, wherein transmitting the set of actual repetitions comprises: transmitting a first actual repetition via a first RB and one or more non-SBFD symbols of the non-SBFD symbols, wherein the first RB is in accordance with a first RB index; and transmitting a second actual repetition via a second RB and one or more SBFD symbols of the SBFD symbols, wherein the second RB is offset from the first RB in accordance with the first RB index, a second RB index associated with a start of an uplink subband associated with the SBFD symbols, a RB offset associated with the SBFD symbols, and a size of the uplink subband.

Aspect 10: The method of any of aspects 8 through 9, wherein a first portion of a first nominal repetition of the set of nominal repetitions spans one or more non-SBFD symbols of the non-SBFD symbols in a first slot and a second portion of the first nominal repetition spans one or more SBFD symbols of the SBFD symbols in the first slot, wherein transmitting the set of actual repetitions comprises: transmitting a first actual repetition of the set of actual repetitions via a first RB and the one or more non-SBFD symbols of the first slot, wherein the first actual repetition corresponds to the first portion of the first nominal repetition; and transmitting a second actual repetition of the set of actual repetitions via a second RB and the one or more SBFD symbols of the first slot, wherein the second actual repetition corresponds to the second portion of the first nominal repetition.

Aspect 11: The method of any of aspects 8 through 10, wherein a first portion of a first nominal repetition of the set of nominal repetitions spans one or more non-SBFD symbols of the non-SBFD symbols in a first slot and a second portion of the first nominal repetition spans one or more SBFD symbols of the SBFD symbols in the first slot, wherein transmitting the set of actual repetitions comprises: transmitting a first actual repetition of the set of actual repetitions via a first RB and via the one or more non-SBFD symbols and the one or more SBFD symbols in accordance with the first RB having a same starting RB index for both the non-SBFD symbols and the SBFD symbols and in accordance with the first RB being within an uplink subband associated with the SBFD symbols, wherein the first actual repetition corresponds to the first nominal repetition.

Aspect 12: The method of any of aspects 8 through 11, wherein a first portion of a first nominal repetition of the set of nominal repetitions spans one or more non-SBFD symbols of the non-SBFD symbols in a first slot and a second portion of the first nominal repetition spans one or more SBFD symbols of the SBFD symbols in the first slot, further comprising: dropping the first nominal repetition in accordance with the first portion and the second portion of the first nominal repetition spanning both the one or more non-SBFD symbols and the one or more SBFD symbols in the first slot.

Aspect 13: The method of any of aspects 8 through 12, wherein transmitting the set of actual repetitions comprises: transmitting a first actual repetition via a first RB and one or more first non-SBFD symbols of the non-SBFD symbols, wherein the first RB is in accordance with a first RB index; transmitting a second actual repetition via a second RB and one or more second non-SBFD symbols of the non-SBFD symbols, wherein the second RB is offset from the first RB in accordance with the first RB index, a first RB offset associated with the uplink symbols, and a size of an uplink bandwidth associated with the non-SBFD symbols; transmitting a third actual repetition via a third RB and one or more first SBFD symbols of the SBFD symbols, wherein the third RB is offset from a second RB index in accordance with the second RB index, a third RB index associated with a start of an uplink subband associated with the SBFD symbols, the first RB offset, and a size of the uplink subband; and transmitting a fourth actual repetition via a fourth RB and one or more second SBFD symbols of the SBFD symbols, wherein the fourth RB is in accordance with the second RB index.

Aspect 14: The method of aspect 13, wherein the second RB index is in accordance with the third RB index, the first RB index, a second RB offset associated with the SBFD symbols, and the size of the uplink subband.

Aspect 15: The method of any of aspects 1 through 14, wherein a first configuration and a second configuration associated with the SBFD symbols are not applicable for transmission of the set of actual repetitions, and the uplink symbols and the subset of the downlink symbols allocated as the SBFD symbols correspond to the valid symbol types.

Aspect 16: The method of any of aspects 1 through 15, wherein the subset of the downlink symbols indicated as the SBFD symbols are valid symbols.

Aspect 17: A UE for wireless communications, comprising a processing system that includes processor circuitry and memory circuitry that stores code, the processing system configured to cause the UE to perform a method of any of aspects 1 through 16.

Aspect 18: A UE for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive control signaling that indicates a pattern of downlink symbols, uplink symbols, and flexible symbols across one or more slots, wherein the control signaling further indicates that a subset of the downlink symbols and a subset of the flexible symbols correspond to subband full duplex symbols;
receive a message that indicates a set of nominal repetitions of a physical uplink shared channel, wherein one or more nominal repetitions of the set of nominal repetitions span at least a portion of the uplink symbols, a portion of the flexible symbols, or both, and span at least a portion of the subband full duplex symbols across the one or more slots; and
transmit a set of actual repetitions of the physical uplink shared channel via the uplink symbols, the flexible symbols, the subband full duplex symbols, or a combination thereof, wherein the set of actual repetitions are identified from the set of nominal repetitions in accordance with valid symbol types.

2. The UE of claim 1, wherein:
the valid symbol types correspond to a symbol type of a first transmission occasion of the set of nominal repetitions in accordance with a configuration associated with the subband full duplex symbols,
the valid symbol types correspond to a symbol type of a first transmission occasion the set of actual repetitions in accordance with the configuration, or
the valid symbol types are in accordance with an indication from a network entity.

3. The UE of claim 2, wherein the valid symbol types comprise the subband full duplex symbols, and the processing system is further configured to cause the UE to:
consider non-subband full duplex symbols as invalid symbol types for the set of nominal repetitions; and
drop an actual repetition of the set of actual repetitions in accordance with the actual repetition spanning one or more non-subband full duplex symbols of the non-subband full duplex symbols.

4. The UE of claim 2, wherein the valid symbol types comprise non-subband full duplex symbols, and wherein the processing system is further configured to cause the UE to:
consider the subband full duplex symbols as invalid symbol types for the set of nominal repetitions; and
drop an actual repetition of the set of actual repetitions in accordance with the actual repetition spanning one or more subband full duplex symbols of the subband full duplex symbols.

5. The UE of claim 2, wherein the valid symbol types comprise the subband full duplex symbols, and wherein, to transmit the set of actual repetitions, the processing system is configured to cause the UE to:
transmit a first actual repetition of the set of actual repetitions via a first resource block of an uplink subband associated with the subband full duplex symbols, wherein the first actual repetition corresponds to an even numbered nominal repetition, and wherein the first resource block is in accordance with a first resource block index; and
transmit a second actual repetition of the set of actual repetitions via a second resource block of the uplink subband, wherein the second actual repetition corresponds to an odd numbered nominal repetition, and wherein the second resource block is offset from the first resource block in accordance with the first resource block index, a second resource block index associated with a start of the uplink subband, a resource block offset, and a size of the uplink subband.

6. The UE of claim 2, wherein the valid symbol types comprise the subband full duplex symbols, and wherein for physical uplink shared channel (PUSCH) Type B repetition with inter-repetition frequency hopping in enabled in the subband full duplex symbols:
a starting resource block of an even numbered actual repetition is given by a starting resource block index;
a starting resource block of an odd numbered actual repetition is given by a starting resource block index of an uplink subband of the subband full duplex symbols plus a first value;
the first value is equal to a second value modulo a size of the uplink subband; and
the second value is equal to the starting resource block index minus the starting resource block index of the uplink subband plus a resource block offset.

7. The UE of claim 1, wherein:
non-subband full duplex symbols and the subband full duplex symbols are valid symbols in accordance with a configuration associated with the subband full duplex symbols, and
the non-subband full duplex symbols comprise the uplink symbols and a second subset of the flexible symbols.

8. The UE of claim 7, wherein, to transmit the set of actual repetitions, the processing system is configured to cause the UE to:
transmit a first actual repetition via a first resource block and one or more non-subband full duplex symbols of the non-subband full duplex symbols, wherein the first resource block is in accordance with a first resource block index; and
transmit a second actual repetition via a second resource block and one or more subband full duplex symbols of the subband full duplex symbols, wherein the second resource block is offset from the first resource block in accordance with the first resource block index, a second resource block index associated with a start of an uplink subband associated with the subband full duplex symbols, a resource block offset associated with the subband full duplex symbols, and a size of the uplink subband.

9. The UE of claim 7, wherein for an actual repetition of the physical uplink shared channel in a subband-full duplex symbol:
a starting resource block of the actual repetition is given by a starting resource block for an uplink subband of the subband full duplex symbols plus a first value;
the first value is given by a second value modulo a size of the uplink subband; and
the second value is given by a starting resource block index of an uplink subband of the non-subband full duplex symbols plus a resource block offset.

10. The UE of claim 7, wherein a first portion of a first nominal repetition of the set of nominal repetitions spans one or more non-subband full duplex symbols of the non-subband full duplex symbols and a second portion of the first nominal repetition spans one or more subband full duplex symbols of the subband full duplex symbols, and wherein the processing system is configured to cause the UE to:
segment the first nominal repetition into a first actual repetition and a second actual repetition at a boundary between the one or more non-subband full duplex symbols and the one or more subband full duplex symbols.

11. The UE of claim 1, wherein the subset of the downlink symbols indicated as the subband full duplex symbols are valid symbols.

12. A network entity, comprising:
a processing system that includes processor circuitry and memory circuitry that stores code, the processing system configured to cause the network entity to:
transmit control signaling that indicates a pattern of downlink symbols, uplink symbols, and flexible symbols across one or more slots, wherein the control signaling further indicates that a subset of the downlink symbols and a subset of the flexible symbols correspond to subband full duplex symbols;
transmit a message that indicates a set of nominal repetitions of a physical uplink shared channel, wherein one or more nominal repetitions of the set of nominal repetitions span at least a portion of the uplink symbols, a portion of the flexible symbols, or both, and span at least a portion of the subband full duplex symbols across the one or more slots; and
receive a set of actual repetitions of the physical uplink shared channel via the uplink symbols, the flexible symbols, the subband full duplex symbols, or a combination thereof, wherein the set of actual repetitions are identified from the set of nominal repetitions in accordance with valid symbol types.

13. The network entity of claim 12, wherein:
the valid symbol types correspond to a symbol type of a first transmission occasion of the set of nominal repetitions in accordance with a configuration associated with the subband full duplex symbols,
the valid symbol types correspond to a symbol type of a first transmission occasion the set of actual repetitions in accordance with the configuration, or
the valid symbol types are in accordance with an indication from the network entity.

14. The network entity of claim 13, wherein the valid symbol types comprise the subband full duplex symbols, and the processing system is further configured to cause the network entity to:
consider non-subband full duplex symbols as invalid symbol types for the set of nominal repetitions; and
drop an actual repetition of the set of actual repetitions in accordance with the actual repetition spanning one or more non-subband full duplex symbols of the non-subband full duplex symbols.

15. The network entity of claim 13, wherein the valid symbol types comprise non-subband full duplex symbols, and wherein the processing system is further configured to cause the network entity to:
consider the subband full duplex symbols as invalid symbol types for the set of nominal repetitions; and
drop an actual repetition of the set of actual repetitions in accordance with the actual repetition spanning one or more subband full duplex symbols of the subband full duplex symbols.

16. The network entity of claim 13, wherein the valid symbol types comprise the subband full duplex symbols, and wherein, to transmit the set of actual repetitions, the processing system is configured to cause the network entity to:
receive a first actual repetition of the set of actual repetitions via a first resource block of an uplink subband associated with the subband full duplex symbols, wherein the first actual repetition corresponds to an even numbered nominal repetition, and wherein the first resource block is in accordance with a first resource block index; and
receive a second actual repetition of the set of actual repetitions via a second resource block of the uplink subband, wherein the second actual repetition corresponds to an odd numbered nominal repetition, and wherein the second resource block is offset from the first resource block in accordance with the first resource block index, a second resource block index associated with a start of the uplink subband, a resource block offset, and a size of the uplink subband.

17. The network entity of claim 13, wherein the valid symbol types comprise the subband full duplex symbols, and wherein for physical uplink shared channel (PUSCH) Type B repetition with inter-repetition frequency hopping in enabled in the subband full duplex symbols:
a starting resource block of an even numbered actual repetition is given by a starting resource block index;
a starting resource block of an odd numbered actual repetition is given by a starting resource block index of an uplink subband of the subband full duplex symbols plus a first value;
the first value is equal to a second value modulo a size of the uplink subband; and
the second value is equal to the starting resource block index minus the starting resource block index of the uplink subband plus a resource block offset.

18. The network entity of claim 12, wherein:
non-subband full duplex symbols and the subband full duplex symbols are valid symbols in accordance with a configuration associated with the subband full duplex symbols, and
the non-subband full duplex symbols comprise the uplink symbols and a second subset of the flexible symbols.

19. The network entity of claim 18, wherein for an actual repetition of the physical uplink shared channel in a subband-full duplex symbol:
a starting resource block of the actual repetition is given by a starting resource block for an uplink subband of the subband full duplex symbols plus a first value;
the first value is given by a second value modulo a size of the uplink subband; and
the second value is given by a starting resource block index of an uplink subband of the non-subband full duplex symbols plus a resource block offset.

20. A method for wireless communications at a user equipment (UE), comprising:
receiving control signaling that indicates a pattern of downlink symbols, uplink symbols, and flexible symbols across one or more slots, wherein the control signaling further indicates that a subset of the downlink symbols and a subset of the flexible symbols correspond to subband full duplex symbols;
receiving a message that indicates a set of nominal repetitions of a physical uplink shared channel, wherein one or more nominal repetitions of the set of nominal repetitions span at least a portion of the uplink symbols, a portion of the flexible symbols, or both, and span at least a portion of the subband full duplex symbols across the one or more slots; and
transmitting a set of actual repetitions of the physical uplink shared channel via the uplink symbols, the flexible symbols, the subband full duplex symbols, or a combination thereof, wherein the set of actual repetitions are identified from the set of nominal repetitions in accordance with valid symbol types.
